(19) United States
(12) Patent Application Publication
(10) Pub. No.: US 2005/0024716 A1
(43) Pub. Date: Feb. 3, 2005

(54) Optical device with immediate gain for brightness enhancement of optical pulses

(76) Inventors: Johan Nilsson, Southampton (GB); Jayanta K. Sahu, Southampton (GB); Joo Nyung Jang, Southampton (GB); Romeo Selvas, Southampton (GB); David C. Hanna, Southampton (GB); Anatoly Grudinin, Southampton (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/619,947

(22) Filed: Jul. 15, 2003

(51) Int. Cl. H01S 3/03

(52) U.S. Cl. 359/341.31

(57) ABSTRACT

Amplifying optical waveguide devices, which, by combining an instantaneous or nearly instantaneous gain medium with pulsed cladding-pumping can convert the multimode pump pulses to higher-brightness (even single-mode) signal pulses. The operating parameters can be carefully matched to the interaction length of the amplifying optical device to promote efficient conversion. The invention combines attractive features of cladding-pumped waveguide devices such as robustness and good thermal management properties with those of synchronously pumped devices. Thus, the pulse energy of the generated beam is not limited by the energy that can be stored in the gain medium.

### FIELD OF THE INVENTION

The invention relates to pulsed optical amplifiers and light sources. By way of example, though not exclusively, the invention relates to single- or few-moded waveguiding lasers, superfluorescent sources, optical amplifiers, high pulse-energy devices, energy-storage devices, cladding-pumped devices, optical fiber devices, and Raman fiber devices.

### BACKGROUND OF THE INVENTION

The power conversion process occurring in a laser (including amplifiers) can serve many purposes. A most prominent purpose of optically pumped lasers is to improve the spatial brightness. Thus, a laser can be seen as a brightness converter that can generate a high-brightness (even single-mode) beam when pumped by lower-brightness multimode sources.

All lasers require a gain medium that can amplify signal radiation via some gain mechanism. Common optically pumped gain media and mechanisms include stimulated emission semiconductors and in doped crystals and glasses (e.g., in the form of optical fibers). The dopant is often a rare earth, e.g., in a Nd:YAG laser or an erbium-doped fiber amplifier (EDFA). Stimulated scattering processes also provide gain, and can occur in any media when optically pumped. Examples include stimulated Raman scattering (SRS) and stimulated Brillouin scattering (SBS), for example, in optical fibers. So-called optical parametric processes can also provide gain, in, e.g., electro-optic materials such as lithium niobate, but also in optical fibers. Fiber lasers and other waveguiding lasers represent an important category of lasers, which are optically pumped with few exceptions. A common configuration for brightness-enhancing fiber lasers is to use so-called cladding-pumping. Cladding-pumping of rare-earth doped fibers has proven a most compelling concept for brightness enhancement [U.S. Pat. No. 4,829,529: Laser diode pumped fiber lasers with pump cavity]. The attractions of fiber lasers include a broad gain bandwidth as a result of using a glass host, spatial beam properties that can be determined by the waveguiding characteristics of the core, and a thin, elongated shape that allows extended interaction lengths with tight confinement and efficient thermal management. Cladding-pumping can also be used with other waveguiding lasers such as planar waveguide lasers [U.S. Pat. No. 6,160,824: Laser-pumped compound waveguide lasers and amplifiers; R. J. Beach et al., “CW and passively Q-switched cladding-pumped planar waveguide lasers”, Opt. Lett., v. 26, pp.881-3, 2001].

So far, optically cladding-pumped devices have generally been pumped with continuous-wave radiation. They can still emit pulsed signal radiation, e.g., when configured as a Q-switched fiber laser, or when amplifying short low-energy pulses, having energies and durations that are small compared to characteristic energies and/or time constants of the amplifying device. Such pulsed signals can, for the purpose of amplification essentially be considered as being continuous-wave.

While cladding-pumping with pulsed radiation is possible, most prior-art devices would effectively time-average the pulsed pump radiation, because of their characteristic time constants. For example, the energy storing property of rare-earth doped gain media is a problem in that the energy of a pulse to be brightness-enhanced can be stored in the gain medium. This can lead to an averaging process that counteracts the pulsed nature of the pumping, to the point where the difference between pulsed pumping and cw pumping can be negated. As a consequence, such a device is quite limited in its ability to brightness-enhance pulsed radiation with pulse energies exceeding the characteristic energy of the device. Gain media with short time constants in which the time averaging can be avoided are therefore normally used for brightness-enhancement and high-energy amplification of pulses, in synchronous pumping schemes. Examples include dye lasers, optical parametric amplifiers, and Ti:Al₂O₃ lasers. Unfortunately, these gain media are not attractive for cladding-pumped waveguide devices. Furthermore, their range of operating wavelengths may be inappropriate.

The limited scope for brightness enhancement of pulses is important. High energy pulses are useful for many important applications, e.g., in materials processing and remote sensing, and pulsed lasers are arguably the most important type of high-power laser. However, the generation of high-energy, high-brightness pulses is difficult: Typically, the energy is first stored in the gain medium before it is released as a pulse, implying that the pulse energy is limited by the stored energy. The storage of energy in a gain medium leads to gain, which is unfortunately associated with dissipative processes such as spontaneous emission, and, in particular, amplified spontaneous emission (ASE). A large beam cross-section is required in order to store large amounts of energy without excessive losses to ASE. In case of a fiber, this means the core must be large, but this leads to a poor beam quality. A waveguiding device that can brightness-enhance pulses while still maintaining the attractions of the waveguide would therefore be desirable.

### SUMMARY OF THE INVENTION

We disclose amplifying optical waveguide devices, which, by combining an instantaneous or nearly instantaneous gain medium with pulsed cladding-pumping, and preferably also restriction of the power conversion process, to a signal waveguide can convert the multimode pump pulses to higher-brightness (even single-mode) signal pulses. In some embodiments, the operating parameters are carefully matched to the interaction length of the amplifying optical device to promote efficient conversion. The invention combines attractive features of cladding-pumped waveguide devices such as robustness and good thermal management properties with those of synchronously pumped devices. Thus, the pulse energy of the generated beam is not limited by the energy that can be stored in the gain medium.

Alternatively, the device can be configured as an add-on module, that can be combined with a multi-mode pulsed source, to generate single-mode, or at least higher-brightness, pulsed radiation.

Thus, it is an objective of the present invention to enable generation or amplification of high-brightness pulsed optical radiation in waveguiding optical devices cladding-pumped with pulsed optical generation.

It is another objective of the present invention to enable brightness-enhancement of pulsed optical radiation via cladding-pumping in waveguiding optical devices.

It is an objective to be able to do this in a wide range of wavelengths.

It is an objective to be able to do this at pulse energies that are high (e.g., 1 mJ or more) compared to energies that can be stored in typical rare-earth doped fibers (typically a few times the intrinsic saturation energy of the fiber).

The waveguiding optical device may comprise a double-clad fiber.

When pumped by a (multimode) optical pulse, the gain medium (typically in the shape of a double-clad optical fiber, provides immediate gain for an embedded signal waveguide. Thus, power can be transferred to a signal pulse, at a signal wavelength, via amplification of it. The amplification is nearly immediate, so that detrimental effects such as buildup of excessive amplified spontaneous emission can be mitigated (they don't have time to build up, or at least not time to expand significant amounts of the pump energy). This implies that the signal pulse must be (nearly) coincidental with the pump pulse. This is often referred to as synchronous pumping. The transfer of optical power from the pump, via the amplification process, is restricted to predominantly occur in the core, by some means. In some configurations, there may be a tendency for further conversion of light, from an intended signal wavelength to other wavelengths. For example, in case of a Raman amplifier, higher-order Stokes radiation can be generated. This may be undesired, and means can be provided for suppression of such undesired further conversion.

Accordingly in one non-limiting embodiment of the present invention, there is provided a source of transversally multi-mode pulsed optical pump radiation and a waveguiding structure. The waveguiding structure comprises a pump waveguide and a signal waveguide, that can guide light along a common, relatively extended, direction. A double-clad optical fiber is a typical, and preferred, example, of the waveguiding structure. The pulsed pump radiation is launched into the pump waveguide of the waveguiding structure. This comprises a gain medium, so that when pump radiation is launched into the pump waveguide, optical gain is created immediately or nearly immediately (relative to the duration of pulses to be generated or amplified, and preferably also relative to the pump pulses), at some wavelength. The gain can be generated via stimulated Raman scattering. The gain medium provides gain for signal light at an appropriate wavelength traveling in a signal waveguide of the waveguiding structure.

The signal light can be injected into the waveguide structure from an external source, or can be generated within the waveguide structure. Furthermore, the signal light is longitudinally spatially overlapping with the pump, or at least does not lag the pump pulse by more than the lifetime of the generated gain. In case the gain medium is short compared to the physical length of the pump pulse, gain is generated in the whole gain medium at the same time. Insofar as the gain is intrinsically bi-directional, the gain through the gain medium will then be similar for co-propagating and counter-propagating signal light. Similarly, if the intrinsic lifetime of the gain (e.g., the fluorescence lifetime of excited ytterbium-ions) is large compared to the time-of-flight of photons through the gain medium, the gain can also be bi-directional. Thus, efficient power transfer from pump to signal is possible both with co-propagating signal and pulse and counter-propagating ones. Alternatively, if the effective lifetime of the gain (determined by the intrinsic properties of the gain medium as well as the duration of the pulse) is short compared to the time-of-flight of photons through the gain medium, we effectively get a “wave” of gain traveling through the gain medium. For efficient amplification, the signal pulse must then travel with the pulse (insofar as gain is generated in the direction of the pump pulse propagation. This would not be the case with amplification via stimulated Brillouin scattering, but SBS has several drawbacks and is not really considered here.)

For efficient operation and brightness enhancement, the power generated (via amplification) must predominantly couple to a signal pulse traveling in the signal waveguide. With some gain media, e.g., rare-earth doped ones, the gain medium can be configured to provide gain primarily for mode (or modes) of the signal waveguide. For example, the RE-doping can be restricted to a signal-guiding core in a double-clad fiber. However, other gain mechanisms (notably SRS), occur in practically all materials, and in preferred high-silica optical fibers, the Raman gain coefficient will often be similar in the signal waveguide (core) and pump waveguide (inner cladding). Thus, since the pump beam overlaps with both the core and the inner cladding gain is generated in both of these structures. While there is some freedom in choosing materials for core and cladding, this freedom and the resulting difference between Raman gain in core and inner cladding can be small. In fact, the Raman gain can even be higher in the inner cladding, because of a higher Raman gain coefficient there, or because the pump intensity may be higher in the inner cladding than in the core (if, for example, pump modes with large overlap with the core have been selectively depleted). This can be a problem even with RE-doped gain media, since Raman gain will still occur in the inner cladding (as well as in the core), and may in some configurations dominate over the gain provided by the RE-doped gain medium.

Thus, several configurations will require, or at least benefit, from means that ensure that power transferred from the pump via the gain medium ends up in the signal pulse rather than somewhere else. There are several ways to achieve this:
Make sure that the gain is higher for the signal mode than for other modes, as mentioned, by appropriate location of a (RE-doped) gain medium, or by selection of a core material with higher Raman gain coefficient.
Use an absorber in the inner cladding, that absorbs signal light but induces low loss at the pump wavelength, and low loss for signal light traveling in the core. For example, a rare-earth can be co-doped into the inner cladding as an absorber with appropriate spectral characteristics. While this is likely to increase the scattering loss in the inner cladding, some of our fiber devices can be short enough to render even a relatively high scattering loss per unit length negligible.
While the pump alone is sufficient for generating, e.g., Raman gain, this only leads to efficient power conversion (via stimulated scattering or emission) if there is also a signal beam propagating through the gain medium. (Spontaneous process lead to negligible power loss.) Thus, it is possible to restrict power transfer to predominantly occur to the signal mode, by seeding the signal mode. One can seed it with signal light from an external light source (pulsed or cw), or by providing feedback for the signal mode. Feedback can be generated with a fiber Bragg grating or with a mirror or a diffraction grating that are external to the Raman gain medium/fiber. Alternatively, instead of a linear cavity with feedback in both ends of the cavity, a so-called ring-cavity can be formed, comprising a closed-loop path at the signal wavelength, within which the signal beam can circulate A suitable output coupling must also be provided, typically by a partially reflecting and partially transmitting device. At the same time the seeding/feedback should be small for undesired modes of the pump waveguide. For example, a standard single-mode fiber that does not contain any pump waveguide can be spliced into the cavity at an appropriate point, where the pump beam has fulfilled its roll. In such an arrangement, a cavity can be formed for the signal waveguide only.

Even if unwanted power-conversion to cladding-modes can be suppressed, it is also possible that power converted appropriately to a signal-pulse guided in a mode of the signal waveguide is further converted. In particular, second-order Raman conversion can occur. This would typically further Stokes-shift the signal light by one (or several) Raman shifts, while maintaining the beam in the signal waveguide. Such cascaded Raman conversion is often a useful effect, in that it allows light at a pump wavelength to be converted to a wide range of signal wavelengths. [U.S. Pat. No. 5,815,518: Article comprising a cascaded Raman fiber laser]. However, it may also be undesired, for example, since each conversion step is associated with a loss of power. While RE-doping can only provide gain at certain wavelengths determined by the spectroscopy, Raman gain can occur at a wide range of wavelengths, determined also by the wavelength of the pump for the Raman process. Thus, a generated signal beam in turn creates Raman gain for higher Stokes orders, and unless means are implemented to suppress it, power conversion to these higher orders will take place if the Raman gain at higher-order Stokes wavelengths becomes sufficiently high. The problem is exacerbated for two reasons: The signal beam is more tightly confined (it is brighter) than the pump beam, and since Raman is a nonlinear scattering effect, a brighter beam leads to higher gain. Furthermore, though, for example, the Raman gain in silica peaks at ˜440 cm⁻¹, the primary pump wavelength in fact induces significant Raman gain directly at the second-order Stokes wavelength (down-shifted by ˜880 cm⁻¹). Thus, the Raman gain at the second Stokes wavelength may well become significantly higher than the Raman gain at the first Stokes wavelength, leading to significant, possibly undesired, further Raman conversion.

Undesired further Raman conversion can be avoided with a filter that suppresses any light at undesired wavelengths (second Stokes wavelength in particular). Several filters are known: Long or short-period gratings can be realized in the waveguiding structure, and be configured to reject light propagating in the signal waveguide out from said waveguide, over a predetermined wavelength range (covering the second Stokes). [U.S. Pat. No. 5,583,689: Filter with preselected attenuation/wavelength characteristic]

Another possibility is to use bend loss. Bending a waveguide creates a wavelength-dependent loss. In most waveguides, the loss will be higher at longer wavelengths, and bend loss can therefore be used to filter out undesired higher-order Stokes generation [U.S. Pat. No. 5,892,615: Output power enhancement in optical fiber lasers]

Yet another possibility is to use a special signal waveguide design, e.g., a fiber with a so-called W core profile. Such fibers can have an enhanced wavelength-dependence of the bend loss so that bend loss filtering can become more effective. In addition, they can have a cutoff-wavelength for the fundamental mode, so that the signal waveguide simply cannot guide light beyond a certain wavelength. The fundamental-mode cutoff wavelength can be chosen to lie between the desired signal wavelength and the wavelength of the undesired second-order Stokes wave. [U.S. Pat. No. 5,892,615: Output power enhancement in optical fiber lasers; U.S. Pat. No. 6,563,995: Optical wavelength filtering apparatus with depressed-index claddings]

One can also co-dope the signal waveguide with an element, for example, a rare earth, that absorbs undesired wavelengths while transmitting the desired signal wavelengths (as well as the primary pump wavelength).

One can also try to enhance the gain at the desired signal wavelength over the gain at undesired wavelengths. For example, if the primary pump wavelength (with multimode pulses) is 1060 nm, one can co-dope the core (signal waveguide) with an appropriate concentration of ytterbium. The ytterbium absorbs the pump, and can then amplify signal light at a signal wavelength of ˜1110 nm. This coincides with the first Stokes wavelength, so light at 1110 nm would experience both Yb-gain and Raman gain. By contrast, Yb would not amplify at the second stokes wavelength of ˜1170 nm. This would only experience Raman gain, with the result that the gain at desired wavelength is enhanced over gain at undesired wavelengths.

A more careful consideration of SRS shows yet another way of avoiding higher-order Raman conversion in a cladding-pumped Raman amplifier: The power conversion from primary pump to first Stokes can be seen as a nonlinear absorption of the pump induced by the signal through the Raman effect. Generally, the Raman-induced gain is intrinsically nearly symmetric around a pump wavelength, but negative on the anti-Stokes side. In our case, however, because the area of the pump beam (in the inner cladding) is much larger than the area of the second Stokes beam (in the core), the second-order Stokes gain is correspondingly higher than the nonlinear absorption of the pump. Thus, for example, with an operating pump absorption of 7.6 dB, the second-order Stokes gain can be estimated to 45 dB if the inner cladding-to-core area ratio equals six. That amount of gain is close to the limit of what is possible without significant power loss (e.g., in the form of spurious lasing at the second-order Stokes wavelength), and this limits the scope for brightness-conversion. Unless second-order Raman conversion can be suppressed in some other way, the area ratio must be kept small enough to avoid higher-order Raman conversion. If the operating pump absorption is reduced, a larger area ratio is possible.

Still, even with these precautions to suppress higher-order Raman scattering, it can still occur if the interaction length is too long (for example, if an optical fiber is too long). The distance required for Raman conversion depends on the optical powers, at higher powers the conversion takes place over shorter distance. After the power has been transferred from the primary pump to the signal, further Raman conversion to higher orders is difficult to suppress. It is often impractical to adjust the device length in order to realize desired conversion characteristics. However, the Raman conversion process can be slowed down, by reducing the effective power of the signal seed, by either simply reducing the actual power of the signal seed or temporally offset the signal relative to the pump somewhat. A temporal offset will normally affect the pulse duration of the output signal pulses. In case the higher-order Stokes conversion can be controlled in some other way, this can be used to control the output signal pulse duration to some degree.

One can also utilize the difference in efficiency that is bound to exist between different pump modes as it comes to their ability to generate gain for, and transfer power to, the signal pulses. Because of this, pump modes with a high such transfer efficiency tend to be depleted first, and after that, the power transfer to signal pulses can be low, even if there is a relatively large amount of pump power still traveling in pump modes with low transfer efficiency. There will be some mixing of modes propagating down the pump waveguide, but this may be small. However, it is possible to apply pump mode-mixing means at different points along the fiber, so that pump power is transferred from modes with poor transfer efficiency to modes with higher efficiency. This way, it is possible to control the rate at which energy is transferred from a signal pulse to a pump pulse. Especially a circularly symmetric structure (perhaps a fiber) is known to have greatly varying pump-to-signal transfer efficiency for different modes. A waveguide/fiber with such properties can therefore be preferable, if this kind of power transfer control is to be used.

For example, pump mode-mixing can be induced by bending a fiber, or with a periodic perturbation (e.g., a grating or a periodic bending of the waveguide). A periodic perturbation is preferably matched to a spacing of the propagation constants of the pump modes (leading to so-called phase matching). The mode-mixing arrangement can be discrete, over a relatively short distance of the waveguide, or can be distributed over a large length of the waveguide.

Alternatively, one can also induce bend loss for the signal mode, to delay the power conversion from pump to signal. Such bend loss is preferably realized without causing any loss for the pump light. Furthermore, it is preferable to minimize the absolute signal power loss (while the relative signal power loss may well be high). Advantageously, any second-order Stokes light generated up to a point where bend loss is induced will, with most types of signal waveguides, suffer even higher bend loss than the signal light/first-order Stokes.

Alternatively, the pump pulses may be controlled, in energy or duration. However, this will also normally affect the energy and duration of the output signal pulses, which may be undesired. For example, one will often want to generate signal with highest possible pulse energy with a given pulse duration.

In any case, if higher-order Raman scattering is to be avoided, the signal pulse is preferably coupled out from the waveguide device at earliest convenience.

More generally, the rate of Raman conversion can be controlled, e.g., with bend loss, mode-mixing, or signal seed power, to generate a desired Stokes order, at a desired Stokes wavelength. In this case, also higher-order Stokes radiation may be seeded with pulsed or cw light at the appropriate Stokes wavelengths. An additional Raman converter (e.g., a length of optical fiber) may be connected to the optical waveguide device, or the optical waveguide device may be extended, to enable higher-order Raman conversion.

More than one pulse pump source can be used, preferably synchronized and launched simultaneously, or with predetermined time offsets, into the optical waveguide structure. The pump sources can be multiplexed and launched through one end of the optical waveguide structure, or through different pump ports if the waveguide has a plurality of pump ports. Especially in the case of short gain media, pulses from the different pump sources can be co-propagating with respect to each other.

One can also have a cw single-mode pump source, that may be co-propagating or counter-propagating with signal and pump pulses, to boost amplification in the signal waveguide.

In example implementations, the pump wavelength may be 1535-1545 nm (EYDFL), and the signal wavelength may be 1615-1640 nm (directly modulated diode, or, at ˜1620 nm, an EDFL.)

In some embodiments higher-order conversion can be used, for example 2nd or 3rd order stimulated Raman scattering.

### BRIEF DESCRIPTION OF THE DRAWINGS

The invention will now be described by way of example with reference to the accompanying drawings, throughout which like parts are referenced to by like references, and in which:

FIG. 1 shows an example of a synchronously pumped pulsed laser according to the present invention.

FIG. 2 shows an example of a pulse-pumped pulsed source according to the present invention.

FIG. 3 shows an example of a synchronously pumped pulse amplifier according to the present invention.

FIG. 4 shows an example of a pulse-pumped amplifier seeded with narrow-band cw signal radiation according to the present invention.

FIG. 5 shows a cross-sectional view of an embodiment of an optical waveguide structure in the form of a planar optical waveguide structure according to the present invention.

FIG. 6 shows a representative Raman gain coefficient spectrum for a high-silica fiber.

FIG. 7 shows an optical waveguide structure.

FIG. 8 shows an optical fiber with a rectangular inner cladding.

FIG. 9 shows an embodiment of a synchronously pumped pulsed laser, similar to FIG. 1, with a Q-switched Er-Yb co-doped fiber laser being used as the source.

FIG. 10 shows for the embodiment of FIG. 9 the DCRF signal gain vs. pump power for 1420 and 940 m long DCRFs.

FIG. 11 shows for the embodiment of FIG. 9 the output power from the DCRF vs. pump power for 1420 and 940 m long DCRFs.

FIG. 12 shows for the embodiment of FIG. 9 simulation results of pump, 1^{st} and 2^{nd} Raman power evolution along the fiber for 90 mW and 140 mW pump power.

FIG. 13 shows for the embodiment of FIG. 9 experimentally obtained output spectrum, measured with an optical spectrum analyzer on the monitor output port for a fiber length of 940 m and a pump power of 140 mW.

FIG. 14 shows for the embodiment of FIG. 9 output pulse shapes at the wavelengths of the pump and first and second stokes beams, measured with the monochromator and a germanium detector.

### DETAILED DESCRIPTION

An amplifying optical waveguide device can be arranged in different configurations, as appropriate for the gain medium used, the characteristics of the multimode pulsed pump source, and the desired output characteristics.

Synchronously Pumped Pulsed Laser

A first configuration is essentially a synchronously pumped pulsed laser. The gain medium is situated inside a cavity, characterized by a round-trip time. The multi-mode pump source emits pulses with a period equal to the round-trip time, or possibly a harmonic or sub-harmonic of the round-trip time. The pulsed pumping leads to periodic gain in the cavity, and like in any laser cavity, signal pulses with temporal characteristics (period, duration) are generated, that make maximum use of the periodic gain. Since the pump repetition rate is matched to the cavity round-trip frequency, the signal pulse, as it circulates through the cavity, will repeatedly overlap with the gain created by the pump pulses. If the transit time through the gain medium is long compared to the lifetime of the gain, the gain will be unidirectional and the signal pulses will preferential travel along the pump pulse. (However, if several signal or pump pulses are simultaneously present in the cavity, they may still “accidentally” collide, in counter-propagating directions, in the gain medium even though the signal pulses are primarily amplified as they propagate along with the pump pulses.)

The power transfer from the pump to the signal occurs sufficiently rapidly so that a high signal gain does not build up, or at least does not lead to large amounts of energy lost to amplified spontaneous emission, which can be an important loss mechanism.

If the gain medium (actually the photon transit time through the gain medium) is short relative to the gain lifetime, the gain may be similar in both directions, and it may be possible to reach laser threshold with signal pulses both co- and counter-propagating with the pump. However, lasers are sensitive to gain differences, so even a small gain difference can make the laser “unidirectional”, with the signal pulses propagating along with the pump pulses rather than against. In a ring-cavity, an isolator can be used to make the device truly unidirectional in an arbitrary direction if the gain is sufficiently high.

For long gain media, the gain medium itself can make up the bulk of the cavity. For example, the gain medium and cavity can be made of a double-clad Raman gain fiber with fiber gratings written in both ends of the fiber.

For both long and short gain media, the cavity can be made longer than the gain medium, e.g., with a fiber delay line.

Signal output coupling from the cavity is provided. For example, a fiber Bragg-grating may be only partially reflecting. A partially reflecting, cleaved fiber end, can also provide serve as a combined feedback/output coupling device. A mirror that can be external to the waveguide device can also be used. A fused fiber coupler can also provide output coupling.

Various means, e.g., for suppressing unwanted SRS to cladding-modes as described above, can be implemented in the amplifying optical waveguide device (synchronously cladding-pumped waveguide laser). In case the pump pulses are such that Raman conversion occurs “too quickly”, and higher Raman conversion therefore threatens, one can detune the pump repetition rate a little from the cavity roundtrip frequency. It may be possible to change the repetition rate of the pump source, or one may be able to extend the cavity length (e.g., with a moving mirror in a free-space path or possibly by stretching a fiber, or possibly with a switch that can select different feedback arms of different length). With such a forced mismatch, only the wing of the signal pulse can be made to overlap with the pump pulse, as a new pump pulse is launched into the cavity, (nearly) at the same time as the circulating signal pulse reaches the pump launch point.

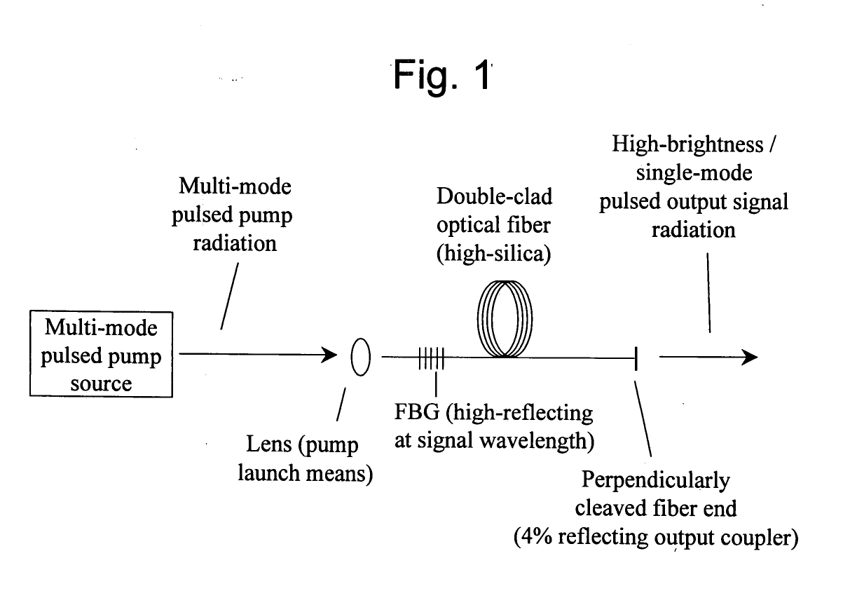

FIG. 1 shows an example of a synchronously pumped pulsed laser according to the present invention.

Pulse-Pumped Source

The gain induced by the pump pulses may be so large that signal radiation is built up from noise (without seeding). In this case there is no seeding of the signal mode, nor any selective feedback for the signal mode, so some other means are required to restrict the generation of signal radiation to the core .(e.g., a signal absorber in the pump waveguide).

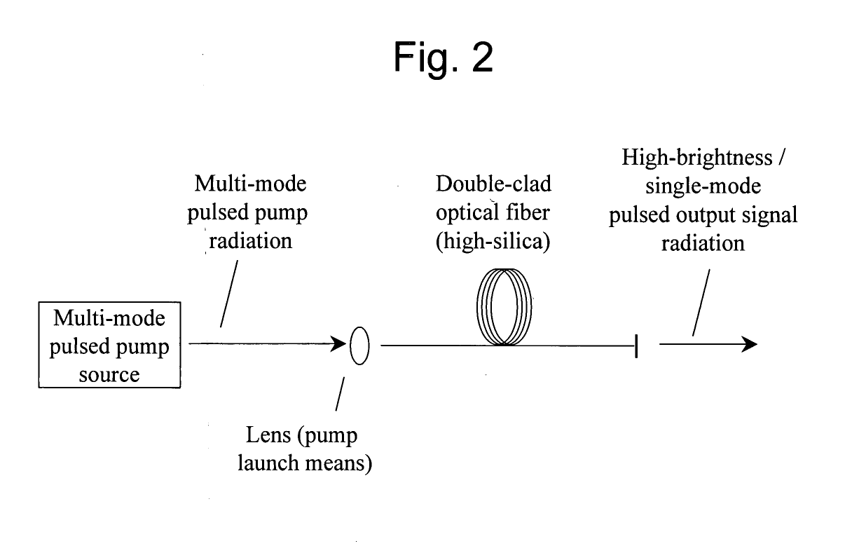

FIG. 2 shows an example of a pulse-pumped pulsed source according to the present invention.

Synchronously Pumped Pulse Amplifier

In this configuration, signal pulses to be amplified are launched at (nearly) the same time as multi-mode pump pulses into a cladding-pumped amplifying optical waveguide device. The power transfer from the pump to the signal occurs sufficiently rapidly that a high signal gain does not build up, or at least does not lead to large amounts of energy lost to amplified spontaneous emission, which can be an important loss mechanism. In case of a short gain medium (in the sense discussed previously), the gain can be significant in both directions so the amplifier can be used either with co- or counter-propagating signal and pump pulses. For a long gain medium, the signal and pump pulses should be co-propagating.

Various means to suppress unwanted power conversion, as discussed above, can be implemented also here.

This configuration requires both a source for pump pulses and signal seed pulses. The pump pulse source may offer ways for realizing the pulsed signal seed source. For example, the pump source may be a MOPA source, with a pulsed single-mode master oscillator amplified in a multi-mode high-energy amplifier. Some of pulsed light from the single-mode master oscillator can be diverted, and Raman-shifted in a single-mode fiber, to realize a single-mode pulsed seed source. By appropriately adjusting the timing (e.g., with fiber delay lines), the single-mode signal seed pulses and the multi-mode pump pulses can be launched at the same time into the cladding-pumped amplifying optical waveguide device.

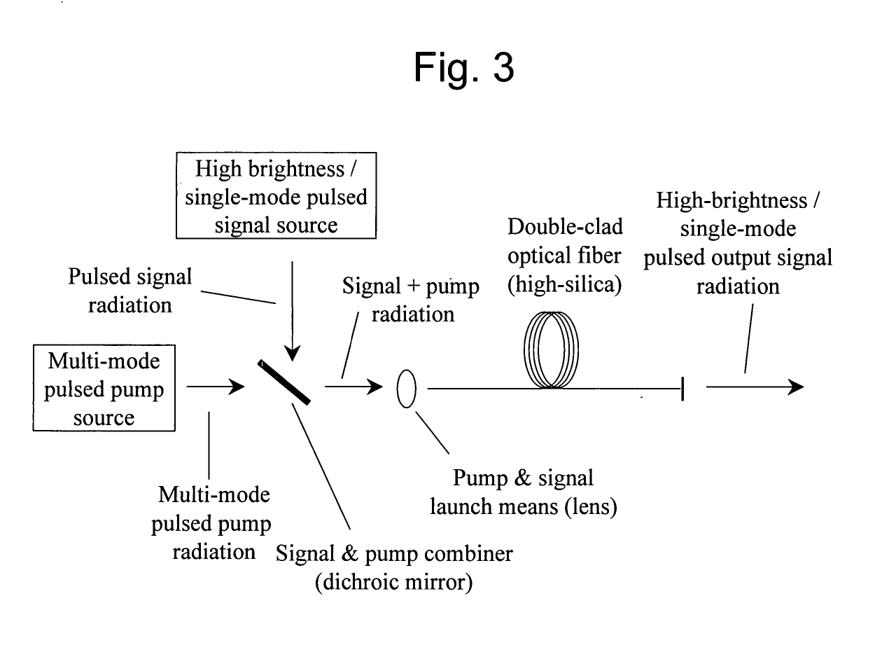

FIG. 3 shows an example of a synchronously pumped pulse amplifier according to the present invention.

Pulse-Pumped Amplifier Seeded with cw Signal Radiation

In this configuration, an amplifying optical waveguide device is cladding-pumped with pulsed radiation, creating temporally short-lived gain in the signal waveguide at a signal wavelength. At the same time, continuous-wave radiation at a signal wavelength is launched into the signal waveguide of the waveguide device. This acts as a seed for power conversion to the signal beam, so that the amplified radiation appears predominantly in the signal beam. Furthermore, since gain appears with a short effective lifetime, the gain temporally follows the temporal shape of the pump pulses. Thus, the signal seed provides spatial selection, while the pump pulses provide temporal selection, so that pulsed, high-brightness radiation can be realized. As before, the gain medium can be relatively long or short, with implications for the direction in which efficient signal gain is obtained. Since signal seed power now equals the relatively low power of a cw-beam, this is typically much lower than the power with pulsed signal seeding. Thus, for efficient pump-to-signal power conversion, a higher gain is normally required in this configuration. Still, the power transfer from the pump to the signal occurs sufficiently rapidly that a high signal gain does not build up, or at least does not lead to large amounts of energy lost to amplified spontaneous emission, which can be an important loss mechanism.

The cw-source can have a narrow optical linewidth. It is generally easier to realize a narrow-linewidth seed source in cw mode than in pulsed mode. If the linewidth is too narrow, stimulated Brillouin scattering can occur, but this can be avoided with a larger signal linewidth.

Various means to suppress unwanted power conversion, as discussed above, can be implemented also here. However, it is not possible to temporally offset seed signal and pump pulses, since the signal seed light is not pulsed in this configuration.

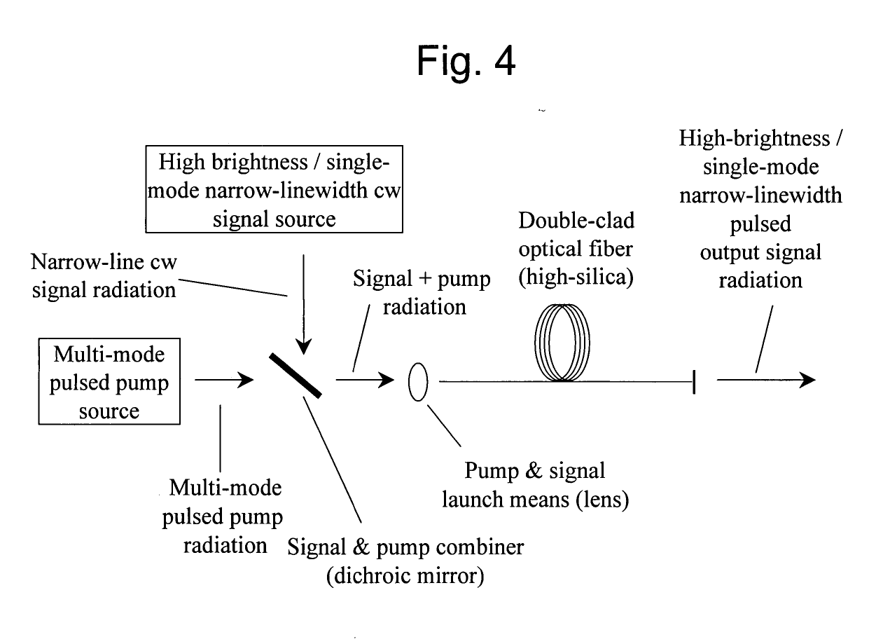

FIG. 4 shows an example of a pulse-pumped amplifier seeded with narrow-band cw signal radiation according to the present invention.

We now give a general description of the components and possible configurations of the invention, and then go on to describe some particular embodiments, and finally describe some special case.

General embodiment of pulse cladding-pumped amplifying optical waveguiding device for generation or amplification of high-brightness pulses

The general embodiment of our invention provides:
an optical waveguide structure, comprising a gain medium, a signal waveguide, and a pump waveguide;
a source of multimode pulsed pump radiation; and
a coupler for launching the pump radiation into the pump waveguide of the optical waveguide structure.

A typical example of the optical waveguide structure is a double-clad optical fiber and other longitudinally extending structures in which the signal waveguide (core) is embedded within a pump waveguide (primarily inner cladding, but strictly also including the core). The structure can be cladding-pumped by launching optical pump radiation into the pump waveguide. Since the pump waveguide is multi-moded, multi-mode pump radiation can be used. When pump radiation of an appropriate wavelength is used, the gain medium creates gain at a signal wavelength. This enables power to be transferred from a pump beam propagating in the pump waveguide to a signal beam propagating in the signal waveguide. The gain medium is such that gain is created immediately, or almost immediately, after pump radiation reaches the gain medium.

The invention can provide a source of high-brightness (e.g., single-mode) signal radiation. The radiation can be pulsed or cw. There are provided coupling means so that the signal radiation can be launched into the signal waveguide of the optical waveguide structure

The invention can provide an optical cavity configured around the optical waveguide structure, so that a laser cavity is formed. The optical cavity comprises feedback that can trap a part of the signal radiation in the cavity, making it recirculate within the cavity and repeatedly pass through the gain medium (i.e., this is a laser). There is also provided an output coupler that couples out a fraction of the signal power as this reaches the output coupler (typically, a fused fiber coupler or a partially reflecting device like a mirror, fiber Bragg grating, or a cleaved fiber or waveguide facet.)

The device can include features and/or components for suppressing transfer of pump power to unwanted radiation fields, in the wrong place, at the wrong wavelength, or at the wrong time.

The invention can further provide synchronization and timing components to allow pump and signal pulses to be launched into the optical waveguide structure with carefully controlled relative timing, and/or to allow pump pulses to be launched into the optical waveguide structure in close synchronization with signal pulses circulating in a cavity formed around the optical waveguide structure.

Optical Waveguide Structure

The optical waveguide structure comprises a gain medium, a signal waveguide, and a pump waveguide. The optical waveguide structure is typically extended in a longitudinal direction, and longitudinally invariant, at least over most of the structure, so that a transverse cross-section of the structure does not vary along the waveguide. The pump and signal beams are guided by the pump and signal waveguides, respectively, along the longitudinal direction of the waveguide. Except for the absorption of the pump needed to create gain in the gain medium, the propagation of the pump and signal is preferably (nearly) lossless, with only a small amount of any unbleachable so-called background losses (e.g., Rayleigh scattering losses).

Clearly, when pumped, the signal gain must overcome any signal propagation losses.

Pump light in the pump waveguide and signal light in the signal waveguide must overlap, and be able to interact, with the gain medium. The pump waveguide can guide multimode pump beams, while the signal waveguide can guide single-mode or nearly single-mode signal beams. Typically, the pump waveguide is relatively large (i.e., has a large cross-sectional area), and has a large numerical aperture so that it can guide many modes, whereas the signal waveguide is smaller, and has a small numerical aperture so that only a single or relatively few signal modes can be guided. Frequently, the signal waveguide is embedded within the pump waveguide. The signal waveguide may be made up with gain medium. For example, a signal waveguide in the form of a fiber core can be made of a material that can amplify.

In a simplified structure, the pump and signal waveguide can be one and the same. In this case, the waveguide may be highly multi-moded for the signal, but with careful seeding of only desired modes, suppression of unwanted signal modes, and/or with selective amplification of desired modes, it may still be possible to generate signal radiation in only a single or in relatively few modes, to realize a high-brightness signal beam. In addition, with a photonic-band-gap waveguiding mechanism, the effective numerical aperture of the signal can be much lower than that at the pump wavelength, so that the waveguide can be (nearly) single-mode at the signal wavelength, while multi-moded at the pump wavelength.

A double-clad optical fiber is a preferred type of the optical waveguide structure. This has a core (typically made with a material with ah higher refractive index) that acts as a signal waveguide. The core is typically embedded in an inner cladding with a lower refractive index. The inner cladding, together with the core, constitutes a pump waveguide. However, since the core is often much smaller than the inner cladding, the pump waveguide is sometimes referred to simply as the inner cladding. The inner cladding is surrounded by a medium with lower refractive index, e.g., a low-index polymer, to enable waveguiding of the pump. Since the surrounding medium is actually an integral part of the pump and signal waveguides, we will use the term pump and signal waveguiding structures to include the surrounding medium.

Waveguiding can also be enabled by photonic bandgap effects, e.g., in a micro-structured fiber.

Generic Description of an Optical Waveguide Structure (Including Fibers)

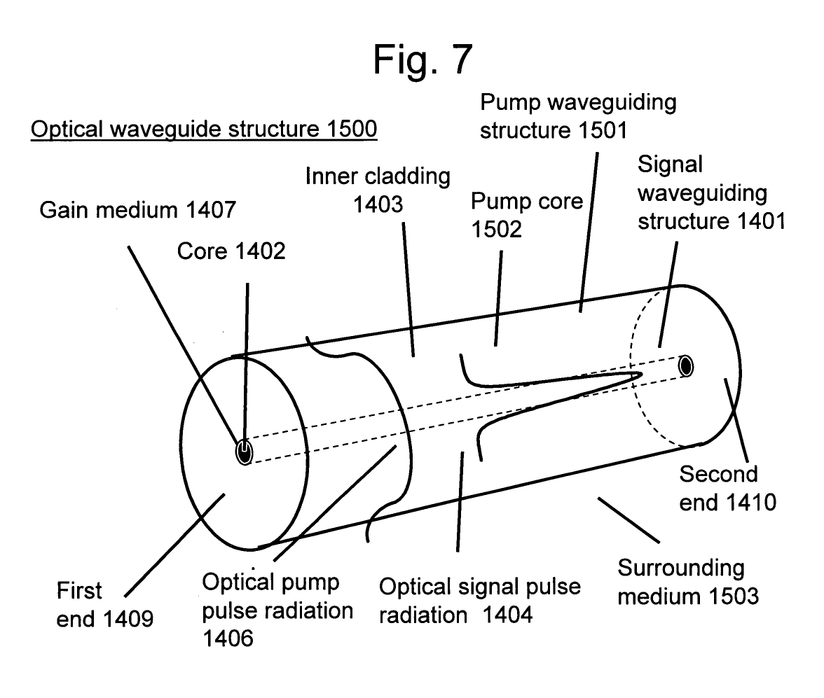

FIG. 7 shows an optical waveguide structure 1500 in more detail, comprising a signal waveguiding structure 1401 comprising a core 1402 and an inner cladding 1403, and configured to guide optical signal radiation 1404; a gain medium 1406 situated in, or in the vicinity of, the core 1402, and wherein the optical signal radiation 1404 guided in the signal waveguiding structure 1401 overlaps the gain medium 1407.

The optical waveguiding structure 1500 further comprises a pump waveguiding structure 1501 comprising a pump core 1502 and configured to guide the optical pump pulse radiation 1406, and wherein the second waveguiding structure 1501 contains the gain medium 1407 and wherein the pump core 1502 is at least partly formed by at least part of the cladding 1403. Optical pump pulse radiation can be optically coupled to the pump waveguiding structure 1501. The core 1402 can form a part of the pump core 1502.

The optical waveguide structure has first and second ends 1409 and 1410. The pump and signal waveguiding structures extend to first and second ends 1409 and 1410, so that optical beams can be coupled into and out of the signal and pump waveguiding structure 1401 and 1501. It is also possible to couple light into the first waveguiding structure 1401 through the side of the amplifying optical waveguide structure 1408. Points at which optical beams can enter or exit an optical waveguiding structure can be referred to as input and output ports, as the case may be. An optical beam launched through a port can exit through the same port, if, for instance, the amplifying optical device is a reflecting traveling-wave amplifier.

FIG. 7 illustrates the optical signal pulse radiation 1404 and the optical pump pulse radiation 1406 with the intensity profile in a cross-section of the beams.

By core 1402, we mean the region of the signal waveguiding structure 1401 where the intensity of the optical signal radiation 1404 is relatively high compared to the intensity of the optical signal radiation 1404 propagating in the inner cladding 1403 in the same transverse section. By way of example only and without limitation, the core 1402 can be that region with a refractive index greater than the refractive index of the inner cladding 1403.

The signal waveguiding structure 1401 can be a single mode waveguiding structure, or can support several higher-order modes, though fewer than what is supported by the pump waveguiding structure 1501.

The optical waveguide structure 1500 can be a planar waveguiding structure or can be an optical fiber. It can be fabricated with high silica content materials. It can be fabricated with other glass materials suitable for fiber or planar waveguide fabrication. It can be fabricated with crystalline materials. High-silica fibers, with high silica content, are preferred.

Though not shown in FIG. 7, it is possible that a waveguiding structure has branches so that a light beam propagating in one waveguiding structure is divided into two beams propagating in different waveguides. Correspondingly, two beams can be combined to one.

The gain medium 1407 can contain at least one rare earth dopant selected from the group consisting of Ytterbium, Erbium, Neodymium, Praseodymium, Thulium, Samarium, and Holmium. It can also contain Europium, Terbium, and/or Dysprosium. The gain medium 1407 can contain at least one transition metal. The gain medium 1407 can contain germanium. The gain medium 1407 can be made of high-silica material. The gain medium can amplify the signal via stimulated Raman scattering. The gain medium must be able to provide immediate or nearly immediate amplification for a signal beam, as soon as it is pumped with pump radiation.

The signal waveguiding structure 1401 can be of a more complicated shape than the traditional ones illustrated in the drawings. For example, it can be non-circular or utilize complicated core designs such as found in W-fibers, multiple cladding fibers (including those with areas in the cladding with a raised refractive-index), segmented core designs, and so-called alpha profiles. Also the pump waveguiding structure 1501 can be of more complicated shape.

In some instances, unwanted radiation can be generated in either the signal or pump waveguiding structures 1401, 1501. In this case, an absorbing medium can be located in the core 1402 or inner cladding 1403. The absorbing medium can contain a rare earth ion. The absorbing medium should not absorb desired pump or signal radiation.

The pump core 1502 is preferably adjacent to a surrounding medium 1503 having a lower refractive index than the pump core 1502, so that the region 1503 provides total internal reflection for the optical pump radiation 1406. The region 1503 can comprise a vacuum, a gas, a liquid, a polymer or a glass. If the optical waveguide structure 1500 is an optical fiber, the polymer can be applied as a coating during the fiber drawing process. The optical waveguide structure 1508 then forms an example of a double-clad optical fiber. A double-clad optical fiber is a preferred optical waveguide structure 1500. Alternatively the second core 1502 can be surrounded by a metal or a periodic layer for reflecting light. Waveguiding can also be achieved with a micro-structured design, for example, the signal or pump waveguiding structures 1401, 1501 can contain longitudinally extensive holes.

It is preferred that the signal waveguiding structure 1401 and the pump waveguiding structure 1501 are fabricated in a single optical fiber.

It is preferred that the signal waveguiding structure 1401 is fabricated from at least one glass system, preferably an oxide glass system selected from the group consisting of silica, doped silica, silicate, and phosphate. The pump waveguiding structure 1501 can also be fabricated from the at least one glass system. By doped silica we mean silica doped with fluorine and/or at least one of the oxides of the following—germanium, phosphorus, boron, tantalum, titanium, aluminum, tin, fluorine, where the oxide dopant concentration is typically up to around 10%. By silicate, we mean doped silica where the dopant concentration is greater than about 10%. By phosphate we mean a phosphate compound glass which includes phosphoria with the addition of other glass forming or modifying agents. In addition, the dopants included in any of the above glass systems can include rare earth and transition elements.

We also note that the optical waveguide structure 1500 can be longitudinally varying.

In order to obtain an efficient device, it is preferred to locate the gain media 1407 and the pump and signal waveguiding structures 1401 and 1501 so that the all of the optical pump radiation 1406 can be transferred to the optical signal radiation 1404 via the gain medium 1407. Otherwise, pump-to-signal power conversion efficiency is reduced.

It is well-known that the shape of the pump core 1502 as well as the location of the gain medium 1407 relative to the pump core 1502 affects the rate at which the gain medium 1407 absorbs the optical pump radiation 1406. In particular, a gain medium 1407 located near the center of a circularly symmetric pump core 1502 may fail to absorb the optical pump radiation 1406 efficiently. Well-known methods for improving the pump absorption are to locate the gain medium 1407 off-center, to use a non-circular pump core 1502 (e.g., rectangular, flower-shaped, or D-shaped [U.S. Pat. No. 5,533,163: Optical fiber structure for efficient use of pump power; U.S. Pat. No. 6,411,762: Optical fiber with irregularities at cladding boundary]), or to bend the optical waveguide structure 1500.

FIG. 7 shows a pump waveguiding structure 1501 that confines light in both directions transverse to the signal waveguiding structure 1401 so that the waveguiding structure 1401 and 1501 are parallel to each other. However, for instance, in a planar structure, the pump core 1502 can be quite wide in one direction and effectively only confine light in one transverse direction. In such a structure, the optical pump radiation 1406 can also propagate at an angle to the signal waveguiding structure 1401.

An optical waveguide structure 1500 can contain several signal waveguiding structures 1401 with gain media 1407. The different signal waveguiding structures 1401 can be optically coupled to each other in series or in parallel, or can be independent.

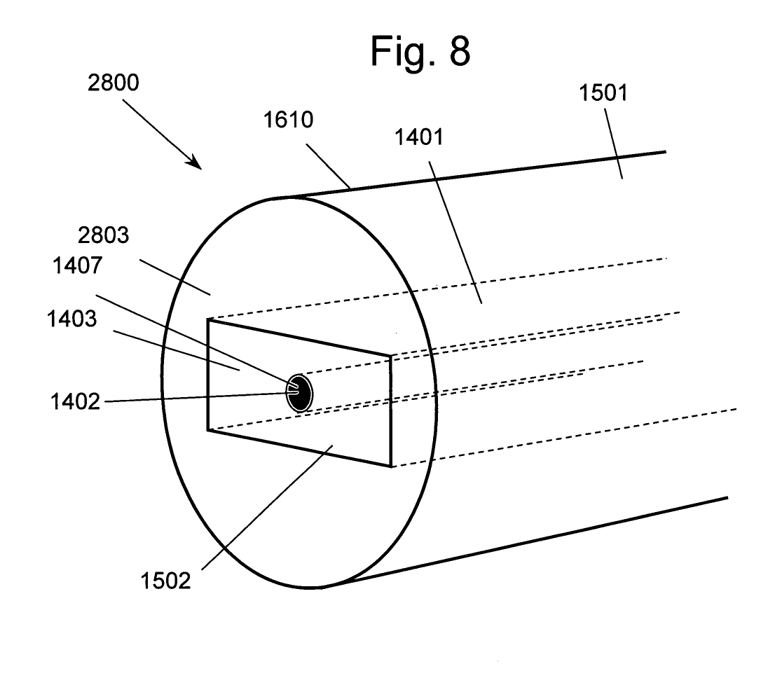

FIG. 8 shows a cross-sectional view of a preferred embodiment of an optical waveguide structure in the form of an optical fiber 1610, having a gain medium 1407 located in the core 1402. Also provided is a pump core 1502 comprising the core 1402 and inner cladding 1403. The pump core 1502 is rectangularly shaped and is located within an outer cladding 2803. The refractive index of the core 1402 is higher than that of the inner cladding 1403, which is in turn higher than that of the outer cladding 2803. The optical fiber 1610 can be made from glass, preferably doped and undoped silica. The fiber can be surrounded by a coating made from a polymer or another material. Alternatively, or as well, the outer cladding 2803 can be made from a polymer.

It is preferred that the first core 1402 is single-moded at a desired wavelength of optical signal radiation 1404.

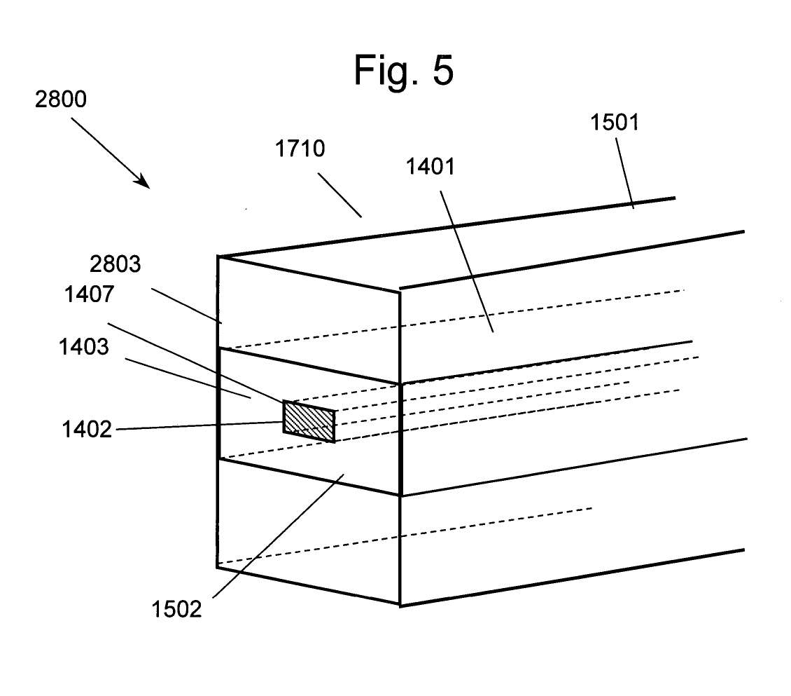

FIG. 5 shows a cross-sectional view of an embodiment of an optical waveguide structure in the form of a planar optical waveguide structure according to the present invention.

Preferred Optical Fiber Designs.

The fiber design and choice of materials are important for an efficient fiber device. The fiber should ideally satisfy many conditions: suppression of higher-order Stokes conversion (e.g., with small area ratio), power handling (optical damage, thermal effects), and a sufficiently large inner cladding for an efficient launch of pump beam. For good conversion efficiency, the ratio of the Raman gain to the propagation loss is a key parameter. Since the Raman gain is inversely proportional to the inner cladding area, a smaller inner cladding would help, provided that an efficient pump launch is still possible. A higher NA can compensate for a smaller inner cladding area, but high inner-cladding NA designs can be problematic for other reasons. Furthermore a circularly symmetric design can be troublesome in that a large fraction of the pump power is coupled to pump modes with poor overlap with the core. The alternative is to try to mix the pump modes, though this may be difficult in fibers with small inner claddings in which the propagation constants of the modes are relatively far apart, at lest if the fibers are short.

For Raman amplification, unless the pump power is very high, the pump waveguide should preferably be as small as possible, since this leads to a higher Raman gain, which is preferable. Still, insofar as the signal waveguide (core) is imbedded within the pump waveguide, the pump waveguide must be sufficiently large for the signal beam to fit within the pump waveguide. The core may have to be large in order to avoid damage problems. Also for non-Raman amplification (e.g., with an ytterbium-doped gain medium), a small pump waveguide (inner cladding) is normally preferable, since this leads to stronger absorption and faster pump-to-signal power conversion. The preference of a small inner cladding is emphasized when the pump wavelength is located away from the absorption peak. This will often be the case.

At the same time, the pump waveguide must be sufficiently large (and have a sufficiently high NA), to allow for efficient launch of the pump into the optical waveguide structure.

It is preferred that the core 1402 is made of a material with high damage threshold. Examples include germanosilicate and pure silica. The fiber end facets 1409 and 1410 can be further modified to increase their damage threshold. For examples, end-caps can be attached to the fiber ends [U.S. 20020168139A1: Optical fiber terminations, optical couplers and optical coupling methods]. The damage threshold of the fiber ends can also be increased with special end treatments (chemical, etching) and with annealing.

For Raman amplification, the inner cladding diameter can lie in the range 20-50 μm. In case generation of higher-order Stokes generation via SRS can be suppressed somehow, or is desired, a larger inner cladding can be used, e.g., 80 μm diameter, if the pump power is sufficiently high to still allow for efficient Raman amplification and SRS.

In case generation of higher-order Stokes generation via SRS is a problem, it can be advantageous to keep the inner cladding-to-core area ratio below ten, or even below six. Preferred core diameters lie in the range 10-20 μm, up to 30 μm. Preferred core NAs lie in the range 0.05-0.1.

Stimulated Raman scattering is a preferred gain mechanism, and gain media that allow for efficient SRS are preferred. Examples include germanosilicate and pure silica.

The following fiber types are preferred for Raman amplification:

All-glass double-clad fiber. In such fibers the light beams are only in contact with glass. The core is typically germanosilicate, while the inner cladding may be germanosilicate or pure silica, and the outer cladding may be pure silica or fluorosilicate. This fiber typically leads to a higher Raman gain in the core than inner cladding, e.g., when the core has a higher germanium content, since a higher Ge-content increases the Raman gain. The listed materials are widely used and can be realized with low loss, though high Ge-contents leads to significantly increased Rayleigh scattering. There are no problems with realizing desired core and inner cladding sizes, and also the outer cladding diameter can be chosen freely, e.g., to 125 μm, for compatibility with standard fibers. Furthermore, the rigidity of an all-glass fiber helps to suppress signal mode coupling, if a larger, multi-mode core is used. On the other hand, the inner-cladding NA with this design is normally relatively low (0.2-0.3 would be typical values, limited by materials consideration), and it is difficult to realize non-circular designs.

Double-clad fiber with polymer outer cladding. Most double-clad fibers are of this type, since materials can be chosen quite freely and fabrication is straightforward. Non-circular geometries with increased interaction between pump beam and gain medium are easy to realize. The core can be made of germanosilicate, while the inner cladding is typically made of pure silica. The outer cladding is made of a polymer with a low refractive index, or sometimes of silicone. Typically relatively high inner-cladding NAs are possible, e.g., 0.4. However, one problem is that the diameter of the glass structure equals the inner-cladding diameter. Therefore, this cannot be made arbitrarily thin, typically at least 50 μm. This is unnecessarily large for most cladding-pumped Raman fiber lasers, reducing the Raman gain and leading to longer fibers. In addition, the pump propagation loss is normally higher than it is with all-glass fibers because of losses in the polymer outer cladding, so fibers should be kept short. This, together with the large inner cladding, increase the pump power requirements.

Jacketed air-clad (JAC) fibers have a silica:air micro-structured (“holey”) outer cladding, and then a protective silica jacket outside of this. The inner cladding is typically silica, and the core germanosilicate JAC fibers can combine a high NA with a small, non-circular, fiber geometry. Inner-cladding NAs of 0.5 or higher are possible. Though their thermal properties are inferior to solid structures, they are still satisfactory for high average power operation [J. Limpert et al., “High-power air-clad large-mode-area photonic crystal fiber laser”, OPT EXPRESS 11, 818-823 (2003)]

Note that the potential for brightness enhancement (from a multi-mode pump beam to a single-mode signal beam) is limited by the V-value of the inner cladding. Assuming an inner cladding diameter of 30 μm and a wavelength of 1.06 μm, we get inner-cladding V-values of 22, 36, and 44, for NAs of 0.25, 0.4, and 0.5, respectively. The number of guided cladding-modes become, approximately, 250, 630, and 990, respectively. A thin, polymer outer cladding fiber with 0.4 NA, 50 μm inner cladding would have a V-value of 59 and guide ˜1800 modes. While this last fiber may be difficult to use for cladding-pumped Raman devices, the scope for brightness-enhancement is as high as 2-3 orders of magnitude.

The described fiber types can also be used with fibers in which a doped gain medium and power transfer via stimulated emission is used, e.g., gain media doped with ytterbium or another rare earth.

Pump Launch

The launch of optical pump radiation into the cladding-pumped amplifying optical waveguiding device is an important aspect. A simple and efficient way is to end-pump the structure. In that case, a pump beam propagating in free space can be focused onto an end of the optical waveguide structure. However, one may want to use several pump sources and launch them at different points into the structure (appropriately synchronized with signal pulses traveling through the waveguide structure. Furthermore, it can be desirable to splice the end of the optical waveguide structure to a fiber that delivers the signal seed light. With the ends free, a double-clad fiber can also be spliced into a ring-cavity. However, splicing the end of an optical waveguide structure generally precludes end-pumping in this end of the optical waveguide structure. Therefore, alternatives to end-pumping have been developed and can be used also with the waveguide structures of the current invention. Several alternatives have been published in the literature and include V-groove side pumping [U.S. Pat. No. 5,854,865: Method and apparatus for side pumping an optical fiber], side-splicing [U.S. Pat. No. 5,999,673: Coupling arrangement between a multi-mode light source and an optical fiber through an intermediate optical fiber length], GTwave fiber devices [EP1175714A1: AN OPTICAL FIBRE ARRANGEMENT], air-clad coils, tapered fiber couplers (manufactured by Lucent or OFS), and side-launching via prisms.

Gain Media and Timing Considerations

An important motivation for the present invention is the realization that large amounts of energy cannot be stored in an optical waveguiding amplifier for any length of time, since this leads to large losses to amplified spontaneous emission (ASE), or even spurious lasing. It is therefore, for instance, difficult to realize high-energy pulse generation and amplification in a cw-pumped device. This is an important limitation of a common prior-art solution.

It is easier to realize high energies in pulses with poor beam quality. An attractive route to generation of high-energy, high-brightness pulses is therefore to first generate high-energy pulses with poor beam quality, and then brightness convert these. This is possible according to the present invention, without requiring large amounts of energy to be stored in the gain medium, at least not for a long period of time (relative to the pulse repetition period and/or the pulse duration). For this to be possible, a proper selection of gain medium, with proper dynamics, and an appropriate timing of pulses is required.

Raman Gain Media

Amplification via stimulated Raman scattering is a preferred type of amplification, and Raman gain media are a preferred type of gain media.

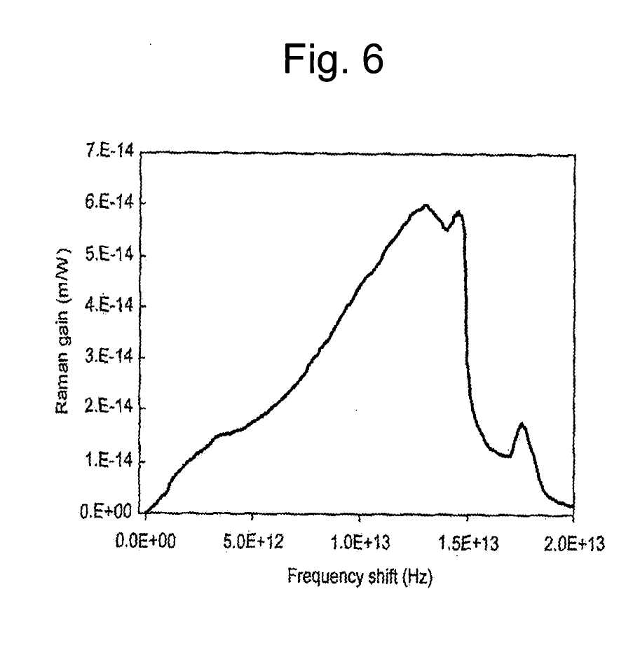

FIG. 6 shows a representative Raman gain coefficient spectrum for a high-silica fiber. A comprehensive discussion of stimulated Raman scattering can be found in [G. P. Agrawal, Nonlinear Fiber Optics, 2^{nd} Ed., San Diego, Calif.: Academic Press, Inc., 1995.]

Except for the very shortest pulses, SRS and Raman gain can be considered to be a truly instantaneous process. When the pump pulse has passed there is no remaining gain. Thus, timing-wise, the signal and pump pulse simply must overlap temporally. Still, Raman gain is essentially isotropic, so occurs both in a pump beam's co-propagating and counter-propagating direction. If a pump pulse is long enough to fill the gain medium, the Raman gain is when this happens, similar in both directions. On the other hand, if the pump pulse is (spatially) shorter than the gain medium, a “traveling wave” of gain is created, and amplification is most efficient for a signal that travels within this wave. This makes the gain effectively unidirectional. Since unwanted ASE (amplified spontaneous emission, or scattering) and spurious lasing via SRS has to build up from noise (at the vacuum fluctuation level), one can realize that if SRS conversion to a wanted signal pulse is seeded, this conversion will dominate over the unwanted conversion, since the seed power will be very much higher than the vacuum fluctuation level.

Raman amplification offers a number of additional advantages, for example:

Operation at any wavelength over the transparency window of the fiber (from visible to ˜2 μm for typical high-silica hosts).

Wide gain bandwidth, e.g., ˜10 THz in silica, as required for amplification of ultra-short pulses

Low quantum defect (˜440 cm⁻¹ in silica, corresponding to less than 5% for a pump wavelength of 1064 nm). Thus Raman gain devices can be highly efficient.

Raman gain occurs in all materials, allowing for widest possible choice of fiber material. For example, a core material with a high damage threshold can be selected.

However, there can still be many problems with Raman amplification, that need to be designed away. These have already been discussed and design solutions have been disclosed, but are here reviewed in greater detail for the purpose of clarifying fiber and device optimization issues.

The wavelength agility means that higher-order Raman conversion is difficult to suppress. This can be undesirable, and it may restrict the scope for brightness enhancement.

It is practically impossible to restrict the Raman gain to the core, since it occurs in any material. While the Raman gain can be controlled by co-dopants to some degree, choice of material may be dictated by other considerations such as low loss.

Raman gain is relatively weak, leading to high pump intensity requirements and potentially long devices.

Because of modal group velocity dispersion (GVD), the walk-off between the signal modes and different pump modes can be significant, especially in long devices.

A simple analysis of a cladding-pumped Raman fiber is helpful. We here consider the cw case. The instantaneous nature means that also short pulses can be treated as quasi-cw.

If we assume an inner cladding diameter of 30 μm, and that the pump is evenly distributed in the inner cladding, the Raman gain becomes 1.4×10⁻⁴m⁻¹W⁻¹ or 0.61 dB m⁻¹kW⁻¹. For simplicity we next consider an amplifier with co-propagating pump and signal. In this case, it can be shown that the output signal power Pₛ^{out} after a fiber of length L is given by
Pₛ^{out}=Pₜₒₜ/[1+(Pₚⁱⁿ/Pₛⁱⁿ)exp(−γ_{R}PₜₒₜL)],
where γ_{R=g}_{R}/Aₚ,Pₚⁱⁿ is the input pump power, and Pₜₒₜ=Pₚⁱⁿ+Pₛⁱⁿ. This expression assumes that propagation losses are negligible. Furthermore the small difference in photon energy between signal and pump wavelength (˜5% around 1 μm) has been neglected—the equation is correct if photon numbers are treated instead of optical powers. The fiber length required to reach a certain value of Pₛ^{out}(Pₛⁱⁿ<Pₛ^{out}<Pₜₒₜ) is given by
L=(γ_{R} Pₜₒₜ)⁻¹ ln [(Pₛ^{out}/Pₛⁱⁿ)(Pₚⁱⁿ/Pₚ^{out})],
where Pₚ^{out}=Pₜₒₜ−Pₛ^{out} (since there is no loss mechanism the total number of photons is conserved). Consider the following numerical example: Pₛⁱⁿ=0.01 kW, Pₛ^{out}=1 kW, Pₚⁱⁿ=1.2 kW (note this is an equivalent power, whereas the true pump power would be 1.2 kW×γₛ/γₚ, where γₛ and γₚ are the signal and pump wavelengths, respectively). Thus, the pump absorption is 82% or 7.6 dB. The length then becomes 47 m. Though the losses in special fibers and at shorter wavelengths are much higher than, say, in optical communication systems, it is still possible to reach, e.g., 10 dB/km at these wavelengths, in which case the loss in a 50 m long fiber is small, if not negligible. A peak power of 1 kW corresponds, for example to an energy of 1 mJ in 1 μs long pulses. It is certainly possible to increase the peak power by two orders of magnitude, e.g., by reducing the pulse duration to 10 ns. The required fiber length would then be reduced by ˜two orders of magnitude, to ˜1 m or shorter. This demonstrates that despite the intrinsic weakness of SRS, at high power it can still be a very effective process. With higher peak powers still, conversion would be possible on a cm-scale, well compatible with planar waveguide structures.

It is also necessary to keep unwanted SRS in check. The pump will induce Raman gain not only in the core but also in the inner cladding. This inner-cladding gain is likely to be similar to the gain in the core. However, pump-to-signal power conversion can still be restricted to the core, if this is seeded with signal light. In the example above, we assume a signal gain of 20 dB. This amount of signal gain is relatively easy to manage, and will only lead to significant power generation in the inner cladding if this is seeded. Thus, insofar as we can avoid launching signal seed light into the inner cladding, undesired low-brightness signal power generation in the inner cladding can be avoided. Alternatively, higher signal gains can be used if there is a signal absorber in the inner cladding, or if the Raman gain can be made significantly higher in the core than in the inner cladding.

In addition, as already discussed, the generated Stokes signal propagating in the core will in turn generate gain at a longer wavelength (second Stokes). This can be used for longer-wavelength signal generation, but since each conversion step is associated with some loss, we for now focus on generating signal light at the first Stokes wavelength. The power conversion from pump to first Stokes can be seen as a nonlinear absorption of the pump induced by the signal through the Raman effect. Generally, the Raman-induced gain is intrinsically nearly symmetric around a pump wavelength, but negative on the anti-Stokes side. In our case, however, because the area of the pump beam (in the inner cladding) is much larger than the area of the second Stokes beam (in the core), the second-order Stokes gain is correspondingly higher than the nonlinear absorption of the pump. Thus, with our pump absorption of 7.6 dB, the second-order Stokes gain can be estimated to 45.4 dB if the inner cladding-to-core area ratio equals six. That amount of gain is near the limit of what is possible without significant power loss (e.g., in the form of ASE or spurious lasing at the second-order Stokes wavelength), and this limits the scope for brightness-conversion. However, a larger area ratio can be used if the operating (nonlinear) pump absorption is smaller (for example the pump can be double-passes). Furthermore, this problem goes away if the higher-order Stokes generation is suppressed by any of the methods already discussed.

The potentially quite short Raman fibers relaxes the requirements on the fiber. For example, jacketed air-clad fibers can be used, that would be difficult to fabricate in km-lengths and that tends to be much more lossy than more traditional fibers. Furthermore, insofar as higher-order Raman conversion would not be a problem, the inner-cladding area can be made larger, for ease of fiber fabrication (fibers with polymer outer claddings can be used), and for easier launch of the pump beam (or for pump beams with worse beam quality).

Assume that we have a fiber with an inner cladding-to-core area ratio of six, corresponding to a diameter ratio of 2.4. Thus the core diameter becomes 12.2 μm if the inner-cladding diameter is 30 μm. This is compatible with single-mode operation at ˜1060 nm—a single-mode core NA of 0.066 would lead to a cutoff wavelength of 1060 nm.

Walk-Off and Pulse Broadening

Because of modal group velocity dispersion (GVD), the walk-off between the signal modes and different pump modes can be significant, especially in long devices. Besides the effectively reduced temporal overlap between signal and pump pulse that this can lead to, it can also lead to pump pulse broadening. Signal pulse broadening is likely to be smaller, because of the (typically) smaller refractive index step of the core and because of the fewer number of signal modes (the core may even be single-moded).

The modal GVD (relative to the group velocity) of a step-index fiber is similar to the relative index step. This may be of the order of 1% up to a ˜5% in high-silica double-clad fibers. Higher-order modes travel slower than lower-order modes. The group velocity is normally slower than it would be in a homogeneous medium with the refractive index of the core. It can be shown that with pump pulse energies in the range 10-100 μJ or more, even the higher of these modal GVDs is likely to be insignificant (compared to the pump pulse duration) over the required device length for Raman conversion. Still, if required, the modal GVD of the pump can be significantly reduced with different graded-index designs, many of which are well-known. The group velocity of the signal will with most designs lie within the range of group velocities of the pump modes.

Special refractive index profiles may allow the signal to have low GVD with respect to pump modes for which the pump-to-signal power transfer efficiency is poor. A low GVD leads to a long effective interaction length. On the other hand, a larger GVD can be tolerated for pump modes with good power transfer efficiency.

In any case, insofar as the relative timing between signal and pump pulses can be controlled, this can always be adjusted for best overall performance. For example, there may be advantages in adjusting the timing so that (the majority of) the pump modes temporally overlap with the signal modes near the end of the fiber. Then, there can be a final, very rapid pump-to-signal energy transfer, near the end of the fiber. This can be beneficial, for example, for reducing nonlinear distortion resulting from self-phase modulation, as well as suppressing higher-order Raman generation.

Amplification Via Stimulated Emission

Amplification is also possible via stimulated emission. Rare-earth doped gain media work via stimulated emission, and can be highly efficient. Especially for the preferred double-clad fiber configuration, rare-earth doping provides the highest efficiency of all stimulated-emission gain media. In particular ytterbium-doped silica fibers can be highly efficient. Transition-metal doping can also be used in gain media.

However, rare-earth doped gain media are characterized by long fluorescent lifetimes, i.e., they are slow, and would therefore appear not to be gain media with fast-responding gain. However, with an appropriate configuration under appropriate operating conditions it is possible realize fast gain response even with rare-earth doped gain media. This enables the energy-storage limitation of cw-pumped and slow-responding gain characteristics to be overcome, in way that is disclosed here.

To realize a fast response in an intrinsically slow gain medium like a rare earth, the response to pumping must be fast. Thus, when a pump photon is absorbed by the gain medium, this should rapidly lead to excitation of an ion into the upper laser level. One way of doing this is to pump directly into the upper laser level (so-called intra-band pumping). Then, the gain medium responds to pumping on a sub-picosecond timescale. However, even with gain media with which intra-band pumping is undesirable for some reason, the response of the gain medium to pumping will still be quick if the relaxation rate from the pump level to the upper laser level is quick. This can occur on a nanosecond scale in many gain media. For example, the relaxation from the pump level around 800 nm in neodymium to the metastable upper laser level is very fast in silica glass. Furthermore, with appropriate choice of host (with a high phonon energy), the dominating multi-phonon relaxation rate can be increased. Thus, a rapid response of the gain medium to pumping can be possible even without intra-band pumping.

Once the gain medium is excited, spontaneous emission begins and ASE builds up. For an efficient energy transfer from pump to signal, this transfer must occur before the losses to ASE (and possibly spurious lasing) become excessive. When a signal pulse is injected into a gain medium, stimulated emission and thus stimulated relaxation of the gain medium occurs on a short time scale (e.g., femtoseconds). Thus, if a signal pulse can extract the energy stored in the gain medium in the form of an inverted population, ASE will not have time to build up, or at least not have time to cause excessive losses. A signal pulse that has an energy exceeding, say, the intrinsic saturation energy Eₛₐₜ=Ahv/(σ^{a}+σ^{a}) (where A is an effective beam area, hv is the photon energy, and σ^{a} and σ^{a} are the cross-sections for absorption and stimulated emission, respectively or twice the saturation energy, can extract most, or even nearly all, of the energy (above the bleaching level for the signal) from gain medium. The saturation energy may be of the order 1-1000 μJ for typical rare-earth doped fibers. Seed pulses with such energies are relatively easy to realize, at least in the lower end of the energy range, so efficient energy extraction and consequently a fast response in the gain medium is relatively straightforward to realize.

If the peak power of the pulses are excessive, or if the fiber length is excessive, stimulated Raman scattering from the signal can dominate over stimulated emission. This may be undesirable, but SRS can be reduced by making the signal pulses longer (though still so short that significant losses to ASE do not occur). SRS from pump to signal can be avoided if the pulses do not overlap in time. In addition, the pump intensities can also be reduced.

The minimum fiber length that is required depends on the dopant concentration. Ytterbium can be doped to high levels in high-silica fibers, of the order of a percent. Such fibers can have pump absorption of, e.g., 2000 dB/m and 100 dB/m, at preferred pump wavelengths of ˜980 nm and in the range 1020-1060 nm for light propagating in the core. The gain per unit length that can be realized is also very high, e.g., several hundred dB/m for preferred signal wavelengths in the range 1030-1100 nm. A fiber device made with a Yb-doped fiber can therefore be short, e.g., 1 m, even if the actual pump absorption is reduced by a factor similar to the inner cladding-to-core area ratio when the pump pulse beam is launched into the inner cladding. In addition, the pump pulse bleaches the absorption as it propagates through the fiber, thereby reducing its own absorption somewhat.

Erbium-doped fibers can be intra-band pumped in the 1470-1550 nm wavelength region and can amplify in the 1530-1620 nm wavelength region. Though erbium suffer from quenching at high dopant concentrations, it is still possible to realize fibers with high enough absorption for realistic device lengths. In particular, certain effects of quenching such as lifetime shortening can be less important for synchronous pulse amplification, allowing for still higher Er-concentrations.

Other possible rare-earth dopants include neodymium and thulium.

Compared to Raman, a rare-earth doped gain medium can be preferable for amplification and brightness enhancement of relatively long pulses (relative the timescales we consider. The pulses should still be short enough to extract the energy from the gain medium before significant ASE power losses occur.)

### FURTHER EXAMPLE EMBODIMENT

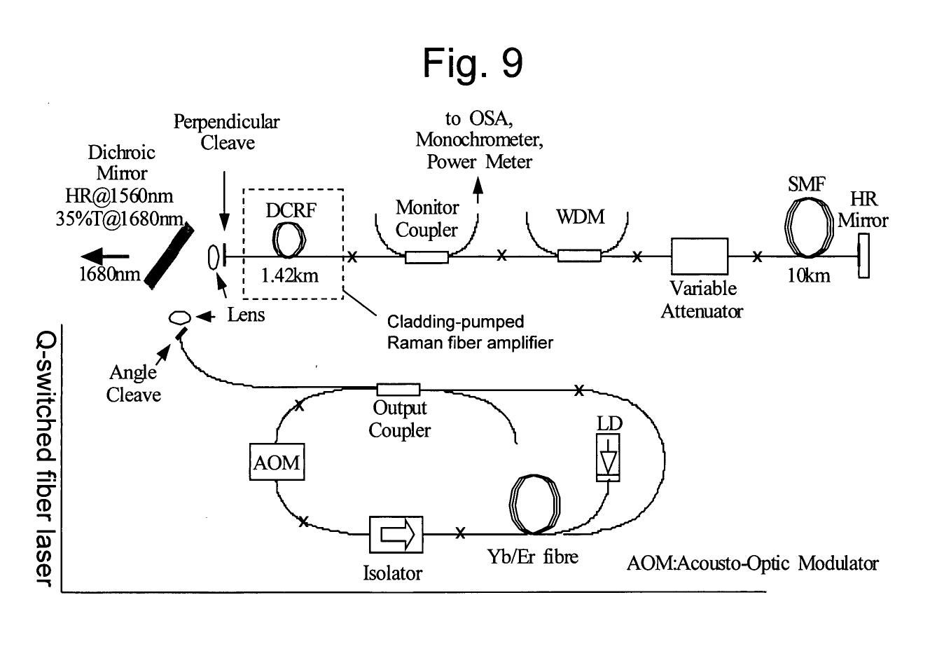

FIG. 9 illustrates an embodiment is a synchronously pumped pulsed laser, similar to FIG. 1 in which a Q-switched Er-Yb co-doped fiber laser is used as the pulsed pump source. Other pump sources can be used as well, including those doped with other rare earths and operating at different wavelengths. Though this pulsed pump source actually generates single-mode radiation at a relatively modest pulse energy level (˜40 μJ), a higher-energy, multi-mode pump source is preferred. The Q-switched fiber laser generated up to 320 mW of average output power at high repetition rates (e.g., 70 kHz). However, at such high repetition rates the pulse energy was small. Instead, the pump laser was used at a lower repetition rate where it generated pulses with energies up to 40 μJ with pulse durations down to 200 ns and with a time jitter of ˜5 ns. The lasing wavelength was 1565-1570 nm. The output from the fiber laser was free-space coupled into a double-clad Raman gain fiber (DCRF) via a dichroic mirror. Though the Q-switched fiber laser produced a single-moded output, we took great care to ensure that the pump beam was launched into the inner cladding, rather than the core, of the DCRF. We could launch up to 88% of the output power from the Q-switched fiber laser into DCRF. Of this power, typically 10-15% was in the core. We varied the launched pump power, without changing the pulse shape, repetition rate, or fraction of power in the core of the DCRF by inducing a bend-loss on the output fiber of the Q-switched fiber laser.

The arrangement in FIG. 9 can be viewed as a synchronously pumped pulsed Raman laser. In the DCRF, the pump source generates Raman gain with a peak wavelength of 1680-1690 nm. Note that the Raman converter itself is very simple, and can be said to consist only of the DCRF. The pump-to-signal conversion takes place in a single amplification pass. Thus the boxed portion of FIG. 9 can be considered to be a cladding-pumped Raman fiber amplifier with input and output ends according to the figure.

The DCRF had a pure silica outer cladding and germanosilicate inner cladding and core, with different germanium contents. The inner cladding had a diameter of 21.6 μm and an NA of 0.22 with respect to the outer cladding. The core had a diameter of 9 μm and an NA of 0.14 with respect to the inner cladding, leading to an estimated cut-off wavelength of 1630 nm. From these NA-values the germanium-content can be determined. The core propagation loss was 3.1 dB/km at 1550 nm. The loss for light in the inner cladding was 2.3 dB/km at 1550 nm. The fiber was 1.4 km long. Since Raman gain is essentially instantaneous and since the pump pulse is much shorter than the DCRF, the pump pulse creates Raman gain that travels with it through the fiber. Therefore, the Raman gain is much higher for signal light traveling with the pump than it is in the counter-propagating direction. Consequently, the signal at the output end of the DCRF will also be pulsed, and temporally coincident with the pump pulse.

The signal pulse emitted from the DCRF continues on through the other components in the cavity. At its output end, the DCRF is spliced to a fused fiber coupler fabricated with standard single-mode fiber (NA 0.12, core diameter 8 μm). The splice loss between standard single-mode fiber (SSMF) and the DCRF was ˜0.5 dB for the core mode. By contrast, since the cladding of the SSMF does not guide light, all pump light except the small fraction in the core is lost here. The coupler had a nearly flat wavelength response, and coupled out 40% of the incident power at ˜1680 nm. The loss for the through-path was 4.3 dB at 1690 nm. This monitor coupler was then spliced to another, wavelength-selective, coupler. It had a low transmission loss (˜2 dB) at the first stokes wavelength (˜1680 nm) but a high loss at the second stokes wavelength as well as at the pump wavelength. Thus, it served as a filter that suppressed higher-order stokes generation. The couplers were followed by a variable optical attenuator (minimum insertion loss at 1550 nm 1.4 dB) that allowed us to change the cavity loss. Finally, there was ˜10 km of standard single-mode fiber (loss at 1690 nm 5 dB): Since the repetition rate of the pump laser was low, the cavity had to be extended to enable synchronous pumping. The standard single-mode fiber was used for this purpose. A high-reflecting mirror was butted to the SSMF in the far end. We estimate the reflection loss to 2 dB.

The signal pulse is reflected back through the cavity all the way to the pump launch end of the DCRF. There, 4% is reflected again from the perpendicularly cleaved fiber end. Preferably, a higher-reflecting, mode-selective, reflector is used instead of the perpendicularly cleaved facet. A fiber grating, written in the core at the right angle can provide higher reflection for the core mode and low reflectivity for modes of the pump waveguide.

At the same time as the signal pulse arrives, a new pump pulse is launched into the DCRF. The reflected signal light acts as a seed for the conversion in the cladding-pumped Raman fiber amplifier. Because the mode-selection that occurs in the SSMF and the low mode-coupling at splice and reflection points, the reflected signal is almost exclusively coupled to the core mode. The roundtrip cavity loss was ˜55 dB. The roundtrip time was ˜115.27 μs, and the Q-switched fiber laser had to be carefully adjusted to a repetition rate of 8.6754 kHz to match this roundtrip time (for synchronous pumping). We used this repetition rate throughout. The pulse energy became 30 μJ and the pulse duration was 210 ns. Thus, the maximum peak power became 140 W, or 540 times the average power. This ratio remained constant also with an attenuated pump beam.

We measured the transmitted pump power with the cavity opened at the end of the DCRF (1.4 km), and found it to be ˜68 mW for 100 mW launched.

In an alternative configuration, a section of the DCRF was moved from its original location to a position between the VOA and the 10 km SSMF. At this point, the DCRF is un-pumped, so this way we could change the effective length of the DCRF without changing the total length or loss of the cavity.

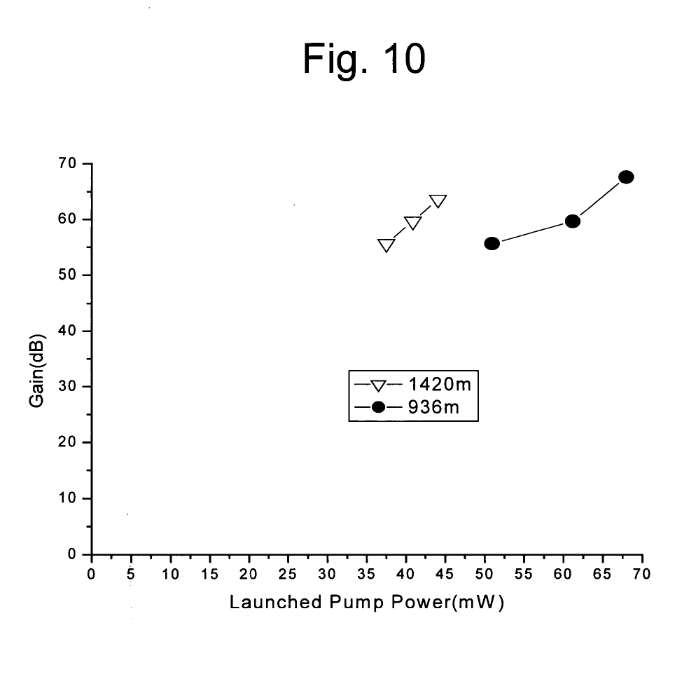

FIG. 10 shows the DCRF signal gain vs. pump power for 1420 and 940 m long DCRFs. The gain was determined by varying the total cavity loss via the VOA, and adjusting the pump power until threshold for lasing was reached. The gain slopes are 1.5 dB/mW and 1.0 dB/mW, respectively. The effective lengths become 1000 m and 740 m. These numbers are in fair agreement with theory, given the uncertainty in evolution of polarization and modal power distribution, and that the high Ge-content increases the Raman cross-section. Beyond the plotted range, laser threshold could not be reached. Still, because of the high pump power, a gain of almost 70 dB could be reached. Significantly, such high gain is enough to generate large amounts of ASE, as required for the pulse-pumped pulsed source of FIG. 2.

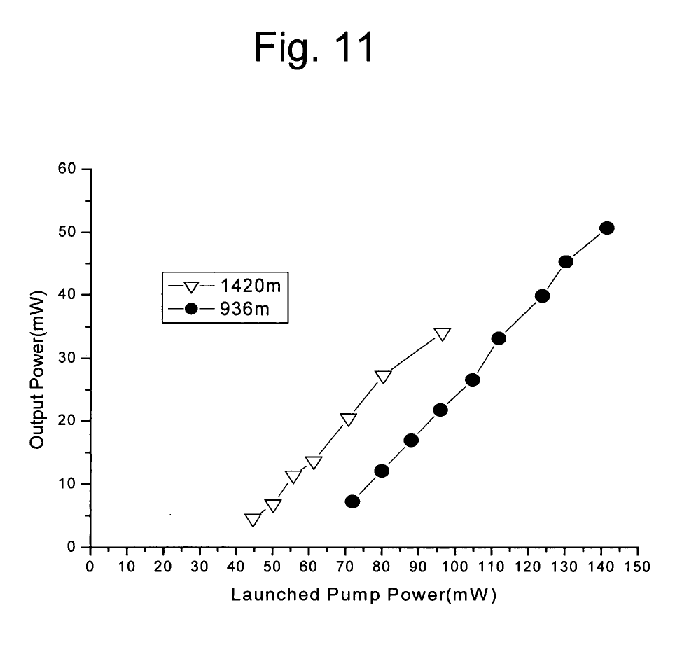

FIG. 11 shows the output power from the DCRF vs. pump power for 1420 and 940 m long DCRFs. For these measurements, the VOA was set to its minimum loss value. The output power was evaluated by measuring the power exiting the coupler monitor port with a thermal power meter and recalculating it to the power coming out from the DCRF. The thresholds are 37 mW and 61 mW, and the slope efficiencies are 60% and 64% for the longer and shorter fiber, respectively. For both fiber lengths, the power in the core at the output end becomes significantly higher than in the input end: The highest pump power launched into the core was 10-20 mW. Significantly, this demonstrates brightness enhancement via Raman amplification of a signal in the core with a pump beam substantially launched into the inner cladding. The high slope efficiency and conversion efficiency that were achieved, even in this long cavity with relatively high loss, are also significant.

In this configuration, for higher efficiency and more output power in the outcoupled signal beam, the signal outcoupling ratio should be higher, and the signal-mode feedback in the pump launch end should be higher, too. Furthermore, the VOA should be removed. It was only used here for experimental purposes.

At high pump power, higher-order Raman generation can occur. In FIG. 11, the pump power was restricted to values for which this was negligible. Thus, since higher-order generation occurs more readily in longer fibers, the maximum pump power for the 1420 m fiber is lower than that of the 940 m fiber.

This shows the significance of matching the fiber length and operating parameters.

To study this further, we simulated our device in the cw regime, using simple, well-known equations for stimulated Raman scattering [G. P. Agrawal, Nonlinear Fiber Optics, 2^{nd} Ed., San Diego, Calif.: Academic Press, Inc., 1995]. Since higher-order Raman conversion is very important in limiting the efficiency of these devices, this was also included in our simulations. The interactions of the pump and 1^{st} and 2^{nd} Stokes waves are given by the following equations:

$$\begin{matrix}\frac{ⅆ {P}_{P}}{ⅆ z} = - {α}_{P} {p}_{P} - \frac{{λ}_{P}}{{λ}_{S1}} \frac{{g}_{1}}{{A}_{eff . S1}} {P}_{P} {P}_{S1} - \frac{{λ}_{P}}{{λ}_{S2}} \frac{{g}_{2}}{{A}_{eff \cdot S2}} {P}_{P} {P}_{S2} & ( 1 ) \\ \frac{ⅆ {P}_{S1}}{ⅆ z} = - {α}_{S1} {p}_{S1} + \frac{{g}_{1}}{{A}_{eff . P}} {P}_{P} {P}_{S1} - \frac{{λ}_{S1}}{{λ}_{S2}} \frac{{g}_{1}}{{A}_{eff \cdot S2}} {P}_{S1} {P}_{S2} & ( 2 ) \\ \frac{ⅆ {P}_{S2}}{ⅆ z} = - {α}_{S2} {p}_{S2} + \frac{{g}_{1}}{{A}_{eff . S1}} {P}_{S1} {P}_{S2} + \frac{{g}_{2}}{{A}_{eff \cdot P}} {P}_{P} {P}_{S2} & ( 3 )\end{matrix}$$

where Pₚ, P_{S1}, and P_{S2} are pump, 1^{st} Stokes, and 2^{nd} Stokes powers. α and λ are corresponding absorption coefficients and wavelengths. g₁ and g₂ are Raman gain coefficients for 12 THz and 26 THz frequency shift, respectively, corresponding to the experimentally obtained shifts. Pump wavelength is 1564 nm and 1^{st}, 2^{nd} Stokes wavelengths are 1690 nm and 1810 nm. A_{eff} is the effective area of the fiber mode. The 3^{rd} term in Eq. 1. represents the interaction between the pump and 2^{nd} Stokes directly. We consider only 1^{st} and 2^{nd} Raman shifts because the 3^{rd} Raman is very small and can be neglected. Signal seed source powers from the synchronously pumping scheme were calculated from the measured power and the total cavity loss. 1^{st} Stokes powers are 2.3×10⁻⁴ mW for 90 mW pumping power and 8.43×10⁻⁴ mW for 140 mW pumping, respectively. We used the experimentally obtained Raman gain coefficient of g₁=0.233 Np/km/mW for the Raman gain peak. For the Raman gain between the pump and 2^{nd} Stokes, we used the Raman gain spectra in G. P. Agrawal, Nonlinear Fiber Optics, 2^{nd} Ed., San Diego, Calif.: Academic Press, Inc., 1995]. The absorption coefficients are 0.53 km⁻¹ for αₚ, 0.714 km⁻¹ for α_{a S1}, and 0.9 km⁻² for α_{S1}. We used the laser repetition rate of 8.6754 kHz for synchronous pumping and the pulse duration time was 210 ns, which means the maximum peak power is 540 times higher than the average power.

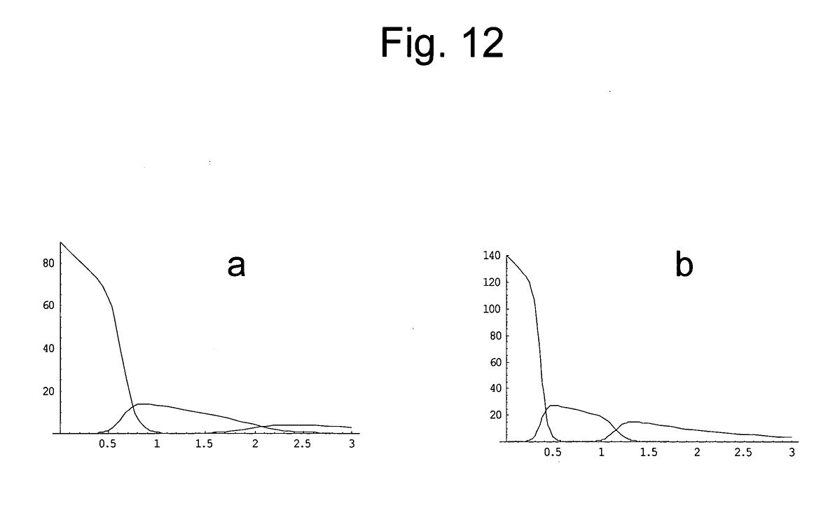

FIG. 12 shows simulation results of pump, 1^{st} and 2^{nd} Raman power evolution along the fiber for 90 mW and 140 mW pump power using the Eq. 1 to Eq. 3. The simulations confirm the onset of 2^{nd}-order Stokes, and illustrates the significance of preventing this from happening.

As we can see in FIG. 12(a), there is no 2^{nd} Raman conversion with 90 mW of pump power within 1.42 km of fiber, but with 140 mW of pump power in FIG. 12(b), higher-order Raman starts to appear after ˜1 km of fiber. At 1.4 km, practically all 1^{st} order Raman power has been converted to 2^{nd} order Raman. These characteristics are in agreement with the experimentally observed behavior.

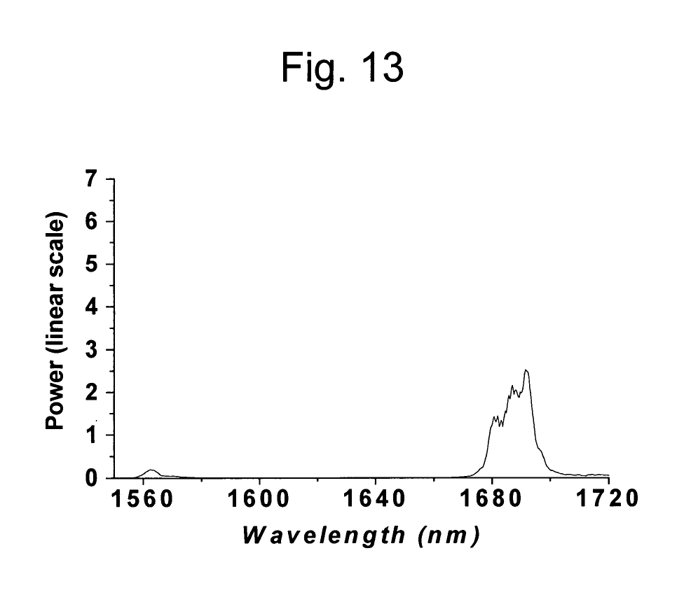

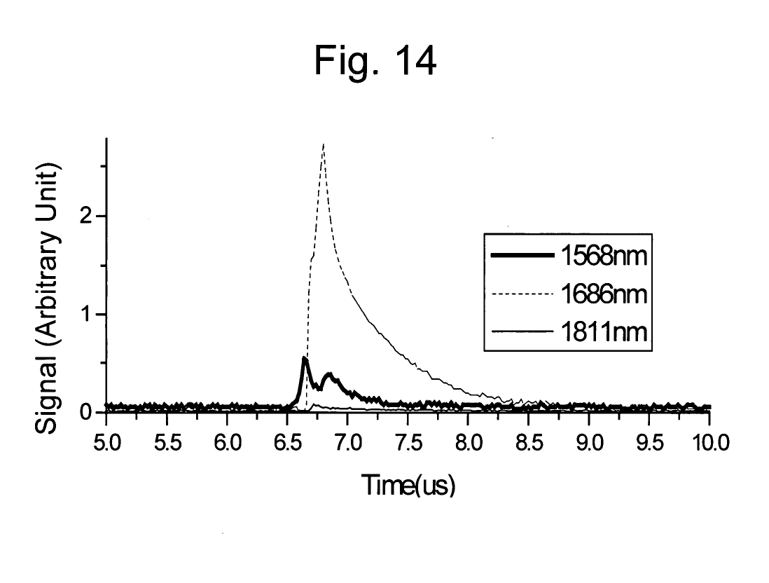

FIG. 13 shows experimentally obtained output spectrum, measured with an optical spectrum analyzer on the monitor output port for a fiber length of 940 m and a pump power of 140 mW. Unfortunately, the spectrum analyzer was limited to wavelengths up to 1750 nm, whereas the second stokes occurred at ˜1810 nm. However, we also used a monochromator to resolve higher-order stokes radiation and for temporal measurements. FIG. 14 shows output pulse shapes at the wavelengths of the pump and first and second stokes beams, measured with the monochromator and a germanium detector. We see that the signal at the second stokes wavelength is much weaker than that at the first stokes wavelength.

Significantly, the fiber was designed with a small inner-cladding-to-core area ratio so that (nearly) the whole pump power, less propagation losses, could be converted to the desired first-order Stokes, without the onset of strong 2^{nd}-order Stokes.

Significantly, the length of the Raman fiber converter was experimentally and theoretically determined to be important. A longer fiber leads to a higher gain efficiency in the small-signal regime. Therefore, it will be easier to reach threshold with a longer fiber, and lower-power pump pulses can be Raman-converted. However, for higher powers, secondary Raman scattering occurs, this too with lower threshold for longer fibers. If this is to be avoided, there will be an upper limit on the pump power for a given fiber length. A shorter fiber has a higher upper limit. In FIG. 11, for pump powers up to 100 mW, the 1420 m fiber is better than the 940 m one. For higher pump powers, second-order Raman scattering occurs in the 1420 m fiber. Consequently, one can reach higher output powers with 940 m of fiber than with 1420 m, if sufficiently high pump power is available. A wavelength-suppressing filter could be used to suppress higher-order Raman scattering, but this may be difficult to realize in practice.

Significantly, in the experiments, SRS to modes of the inner cladding was avoided by suppressing radiation in the cladding-modes in the standard single-mode fiber.

While the above invention has been described with particularity to specific embodiments and examples thereof, it is understood that the invention comprises the general novel concepts disclosed by the disclosure provided herein, as well as those specific embodiments and examples, and should not be considered as limited by the specific embodiments and examples disclosed and described herein.

1. A waveguide device comprising:
a pump source operable to generate a pulsed pump beam pulsed at a pump frequency and having a pump wavelength; and
an optical waveguide structure comprising a signal waveguide and a pump waveguide, wherein the optical waveguide structure is arranged to receive the pulsed pump beam into the pump waveguide, and wherein the signal waveguide contains a gain medium that is responsive to the pump wavelength to provide instantaneous or near instantaneous gain at a signal wavelength offset from the pump wavelength and thereby generate a signal beam that amplifies by drawing energy from the pump beam.

2. The device of claim 1, wherein the pump beam has pump pulses having a pump pulse length and the optical waveguide structure has a length that is less than the pump pulse length, so that each pump pulse induces instantaneous or near instantaneous gain in the signal waveguide along the length of the optical waveguide structure simultaneously.

3. The device of claim 2, wherein at least one of the pump source and the optical waveguide structure are configurable to set the pump frequency to match a round trip frequency of the optical waveguide structure, to provide synchronous pumping.

4. The device of claim 1, wherein the pump beam has pump pulses having a pump pulse length and the optical waveguide structure has a length that exceeds the pump pulse length, so that each pump pulse induces instantaneously or near instantaneously a traveling gain field in the signal waveguide that moves through the optical waveguide structure.

5. The device of claim 4, wherein at least one of the pump source and the optical waveguide structure are configurable to set the pump frequency to match motion of the traveling gain field in the signal waveguide, to provide synchronous pumping.

6. The device of claim 1, wherein the optical waveguide structure includes an optical fiber.

7. The device of claim 6, wherein the optical fiber comprises: a core that forms the signal waveguide; an inner clad that forms the pump waveguide; and an outer clad.

8. The device of claim 1, wherein the instantaneous or near instantaneous gain is generated by stimulated Raman scattering.

9. The device of claim 8, wherein the signal waveguide of the optical waveguide structure is substantially free of rare earth elements.

10. The device of claim 1, wherein the instantaneous or near instantaneous gain is generated by stimulated emission from an energy band populated by the pump beam.

11. The device of claim 10, wherein the signal waveguide of the optical waveguide structure is doped with a rare earth element to provide said energy band.

12. The device of claim 1, wherein the pump source is a Q-switched laser.

13. The device of claim 1, wherein the pump source is an optical fiber laser.

14. The device of claim 1, wherein the pump source is a Q-switched optical fiber laser.

15. The device of claim 1, wherein the pump waveguide has a cross-sectional area relative to that of the signal waveguide that is sufficiently small to suppress higher order inelastic scattering, e.g. a ratio of 4-8.

16. The device of claim 1, wherein the pump waveguide includes an absorber material that is relatively low loss for the pump beam and relatively high loss for the signal beam.

17. The device of claim 1, further comprising a seed source for providing a seed beam at the signal wavelength, wherein the optical waveguide structure is arranged to receive the seed beam from the seed source into the signal waveguide.

18. The device of claim 1, wherein the optical waveguide structure is configured so that at least a portion of the signal beam is fed back to provide a seed beam at the signal wavelength.

19. The device of claim 18, further comprising at least one reflector arranged to feed back at least a portion of the signal beam for seeding.

20. The device of claim 18, wherein the optical waveguide structure is arranged in a ring to feed back at least a portion of the signal beam for seeding.

21. The device of claim 1, wherein the signal wavelength is offset from the pump wavelength by an amount characteristic of a single inelastic scattering event.

22. The device of claim 1, wherein the signal wavelength is offset from the pump wavelength by an amount characteristic of first and second inelastic scattering events.

23. The device of claim 1, wherein the first and second inelastic scattering events have a common characteristic energy.

24. The device of claim 1, wherein the first and second inelastic scattering events have different characteristic energies.

25. The device of claim 1, wherein the signal wavelength is offset from the pump wavelength by an amount characteristic of at least first and second inelastic scattering events.

26. The device of claim 25, wherein the length of the gain medium is selected to have a length suitable for generating a desired higher order Stokes component.

27. The device of claim 1, wherein the optical waveguide structure is predominantly made of silica.

28. The device of claim 1, further comprising a cavity arranged around the optical waveguide structure to form a laser.

29. The device of claim 1, wherein the instantaneous or near instantaneous gain is generated by inelastic scattering.

30. The device of claim 1, wherein the length of the gain medium is sufficiently small to suppress higher order inelastic scattering

31. The device of claim 1, wherein the pump beam is multimode.

32. A method of generating a signal beam, comprising:
providing an optical waveguide structure comprising a signal waveguide and a pump waveguide;
generating a pulsed pump beam having a pump energy;
introducing the pulsed pump beam into the pump waveguide; and
generating a signal beam by instantaneous or near instantaneous gain in the signal waveguide at a signal energy offset from the pump energy.

33. The method of claim 32, wherein the instantaneous or near instantaneous gain is produced by stimulated Raman scattering.

34. The method of claim 32, wherein the instantaneous or near instantaneous gain is produced by stimulated emission.
